(19) United States
(12) Patent Application Publication
(10) Pub. No.: US 2007/0276548 A1
(43) Pub. Date: Nov. 29, 2007

(54) Power Switch

(76) Inventors: Nikola Uzunovic, Copenhagen N (DK); Martin Johansson, Frederiksberg (DK); Erik Damgaard, Hellerup (DK); Morten Risager, Glostrup (DK)

Correspondence Address: KNOBBE MARTENS OLSON & BEAR LLP, 2040 MAIN STREET, FOURTEENTH FLOOR, IRVINE, CA, 92614, US

(21) Appl. No.: 10/577,873

(22) PCT Filed: Oct. 29, 2004
(86) PCT No.: PCT/DK04/00753

§ 371 Date: May 22, 2007

(30) Foreign Application Priority Data
Oct. 30, 2003 (DK) PA 2003 01615
Aug. 31, 2004 (DK) PA 2004 01317

(51) Int. Cl. G05D 11/00

(52) U.S. Cl. 700/297

(57) ABSTRACT

The present invention relates to a power switch, data system, interface and a data structure for controlling power outlets on one or more power switches. Each power switch comprises a sensor bus and watt meters in order to be able to monitor power consumption and environmental changes. Furthermore the power switches comprises a memory and a processor in order to be able to automatically control the power outlets without interference from a user terminal.

### FIELD OF THE INVENTION

The present invention relates to apparatuses and methods for managing of electronic devices, for example computers, servers, printers, etc. More specifically, the present invention relates to Computer controlled power distribution units.

### BACKGROUND OF THE INVENTION

In the past few years the number of servers, printers and other electronic devices has increased rapidly. The trend of an increasing number of electronic devices makes it very difficult for network administrators to control an entire network and its devices. For this reason, support tools have been developed in order to ease the burden experienced by administrators. One example of such support tool is power switches.

Power switches that are able to control power to a number of devices exist. However, existing power switches have many drawbacks. Usually these power switches have a simple on and off functionality, although some may also perform a controlled on/off sequence. However, they are not able to control the power on/off and/or sequence in an intelligent way. There are also power switches that have watt meters and sensor ports for measuring for example the overall power consumption for devices connected to the power switch.

Furthermore, existing power switches are usually not a part of a bigger control system and is usually not in direct contact with for example a central control unit. Thus existing power switches are suitable for smaller systems such as a home office only having a few devices to be controlled.

Moreover, existing power switches lack the ability to react independently without receiving instructions from a control unit. This may result in a very long reaction time, which may decrease the up-time for a server. For companies hosting servers as a business the up-time is very important because the customers renting the servers expect that their homepage or Internet store to be online 24 hours a day. Just a few minutes of server failure can potentially result in the loss of customers.

Furthermore the power switches may not only control computer related equipment. Other kinds of equipment may be controlled by power switches as well, such as pumps, sprinkler systems, and similar.

Some other drawbacks are encountered with the power switches that are being manufactured today. For example it is not possible to group the power switches into different groups, and they are not compatible with different kinds of electronic devices. Another weakness experienced with existing power switches and the control units, is their user interface. For example the user interfaces have security flaws which make it possible for hackers to access the power switch and cause unexpected power failure in a network.

### SUMMARY OF THE INVENTION

Thus it is an object of the present invention to provide enhanced power switches for the management of electronic devices or other electrical equipment.

It is another object of the present invention to provide a network of power switches facilitating individual control of each power outlet in the network.

It is another object of the present invention to provide a user interface for facilitating the management of electronic devices.

It is a further object of the present invention to provide a method of grouping electronic devices or other electric equipment.

It is an advantage achieved by the present invention to provide power switches that are able to react to input without external interaction from for example a control unit.

It is further an advantage achieved by the present invention to provide a power switch system facilitating expansion/reduction of the system without interference from a control unit.

Other objects and advantages of the present invention will be apparent from the following description.

According to a first aspect of the invention, there is provided a power distribution device for controlling and monitoring states in and around a computer network, the device comprising:
at least one processor,
at least one memory,
at least one sensor port for receiving a sensor signal,
at least one sensor, for example at least one watt meter,
at least one power outlet, and
a connection to a communication network,
   wherein the processor is operable to control said at least one outlet in response to information provided from the at least one sensor port and/or the at least one sensor and/or information provided from said communication network.

Thus the present invention provides a PDU that is able to communicate with many other entities such as other PDUs, user terminals such as PCs, PDAs or mobile phones comprising a user interface. Furthermore the PDU is able to react according to predetermined rules stored in the internal memory and to obtain information about the surroundings through the sensors. Based on at least some of the information retrieved from the surroundings the PDU may be able to control and monitor states such as changing the states on one or more of the outlets.

According to a second aspect of the invention, the above and other objects are fulfilled by a user interface for a user terminal connected to a computer network comprising network devices, the user interface comprises a display and at least one panel/window, wherein the at least one panel comprises one or more elements.

Thus the present invention further provides a user interface that makes it possible to structure the devices in the network and to manage the devices in a very user-friendly environment.

According to a third aspect of the invention, the above and other objects are fulfilled by a method for collecting and storing data from unknown devices in a network environment, the network environment comprises a network, a user terminal, a home database, unknown network devices and a first database comprising usage information about the unknown network devices, the method comprises the steps of: from the user terminal sending a request to a proxy/transparent layer for finding network devices, the proxy/transparent layer finds and connects to unknown network devices, and when an unknown network device is found, collecting and storing data relating to the unknown devices in the home database.

By this method it may, among other things, be possible to integrate unknown power switch devices having a different set of control instructions. Preferably this is achieved by having a first database comprising usage information/control instructions related to the unknown devices.

The databases may be located in the user terminal. However it may be preferred to have a dedicated online server comprising the database. The online server may be updated with the newest information related to “unknown” power switch devices.

In this context “unknown devices” preferably relates to power switches manufactured by other manufacturers.

If an administrator is using a user terminal in the form of a mobile phone or PDA it is preferred that the database is either on a server or in a computer such as a PC. In this arrangement the small user terminal does not have to contain all the data, instead it can contact the database on the server and retrieve the necessary data.

According to a fourth aspect of the invention, the above and other objects are fulfilled by a method for creating a database comprising devices in a network, the network comprising: at least one user terminal, a multiple of network devices and at least one power distribution device comprising sensors and outlets for controlling the power to the network devices, the method comprises the steps of: scanning the network for new power distribution devices, upon a request sent from the user terminal receiving at least one message from each new power distribution device, assigning a belonging to the new power distribution device, creating a record relating to each new device, and storing the record in a database.

In this way it is possible for the system to obtain a database comprising a list of the power outlets, wherein the outlets preferably are assigned a belonging. The belonging of the power outlets makes it possible to group them into different groups. For example some of the outlets on one PDU may belong to a customer A, and some outlets on an other PDU may also belong to the customer A. By giving the outlets the “belonging” customer A, it is possible to group and to display the outlets on a display. An administrator only has to choose that he/she wants to display the outlets related to customer A, and the outlets related to customer A will be displayed. Hence there is no need to know on which physical PDU the outlets are located, the system and software takes care of that.

In this way a user may experience that all outlets in the system belong to a giant power switch.

If the administrator wants to choose “power off” on all the devices belonging to customer A he/she only has to choose “customer A” on the user interface and subsequently, he/she can mark a check box for all outlets or mark the outlets he/she wants to close and choose the appropriate action, in this case “Switch Off”.

Furthermore, several belongings may be associated to an outlet, for example if customer A has a number of printers the outlet may have the belongings “customer A” and “Printer”. In this way the administrator may be able to choose only turn off the printers for customer A.

These are only a few examples of belongings and grouping of outlets, many other combinations and belongings may be used.

Moreover the method may also be used for finding any PDU not only new PDUs, thus the method may also be used for updating the database.

Furthermore many different types of devices may be attached to the outlets of the PDUs, as long as they are dependent on some kind of power that may be controlled by the PDU.

According to a fifth aspect of the invention, the above and other objects are fulfilled by a method for controlling power distribution devices in a network, the network comprises: at least one user terminal comprising a display, a multiple of network devices, one or more power distribution devices comprising sensors and multiple outlets supplying power to the network devices, the method comprises the steps of: displaying the power distribution devices and/or outlets according to a belonging of the distribution devices and/or outlets, controlling the power distribution devices and/or outlets according to an action triggered by an input.

In a sixth aspect of the invention, the above and other objects are fulfilled by a computer system comprising: one or more power distribution devices(s) comprising power outlets, a user terminal comprising a display for displaying information relating to the power outlets, one or more electronic devices connected to the power outlets, said computer system being programmed to: displaying on the display, information relating to one or more of the power outlets according to predetermined belongings of the power outlets,

Thus the present invention provides a computer system that makes it possible for an administrator to manage the system from a user terminal such as a PC computer, or a mobile phone, PDA or any other portable electronic device that can connect to the Internet. Hence the administrator is able to login and control the system independently of his/her location. This facilitates the work for an administrator and increases the up-time of the system.

In a seventh aspect of the invention the above and other objects are fulfilled by a data structure comprising: at least one outlet block comprising data relating to an outlet, at least one sensor block comprising data relating to a sensor, and a password block.

By utilising this data structure the PDUs may be controlled by application software since the application software is able to update the data in the data structure and communicate with the PDU by sending the data structure to the PDU.

The data structure may further comprise: a network block comprising data relating to the network, a power distribution device block comprising data relating to the power distribution device, a sequence block comprising data relating to the order of switching outlets on or off. a communication block comprising data relating to sending electronic messages.

The data structure is preferably adapted to be transmitted over a network in order to facilitate the updating and storing of information.

The data structure may preferably be XML code, however any other kind of data structure such as a list comprising list elements or arrays, etc. may be used.

Power Distribution Device—PDU

Each PDU preferably comprises a processor, a memory, a unique ID code and network means so that the PDUs may be interconnected in a network. In this way it is possible for the PDUs to communicate with each other without a user terminal. Hence the system can work even though the user terminal is disabled or broken.

Furthermore it is possible to connect the PDUs to a network by using a network bridge which converts digital or analogue signals from the user terminal into or out from the network. The signals may be sent by wire or wireless. Thus as long as the user terminal is able to access a PDU, the PDU accessed by the user terminal may work as an intermediary device which is able to forward the instructions to other PDUs.

Each PDU may comprise a unique code stored in the memory for identification when the PDU is connected to a network of PDUs. This makes it possible to supervise PDUs being connected to or disconnected from the network. Furthermore the ID makes it possible for the system to automatically find and configure new PDUs being connected to the network.

Since each PDU preferably comprises a processor and a memory it is possible to transfer instructions and store them in the memory. Hence the PDU will be able to act on its own in case the connection to the user terminal is down or if the PDU should be disconnected to the network of PDUs. Furthermore the PDU is able to react on other inputs such as inputs from sensors or other PDUs, network devices, etc.

The power distribution device may comprise a number of outlets, the number of outlets preferably being eight, however, as long as it is practical to handle the device there is no upper limit of the number of outlets on a PDU.

Furthermore the PDU is able to measure different types of states/values since it preferably comprises sensor ports. The sensors connected to the sensor port may be any kind of sensors or meters, such as temperature sensors, smoke sensors, movement sensors, light sensors, water sensors, current meters, effect meter, sound sensors, etc.

The sensors preferably send signals to the processor in the PDU and the PDU is able to react accordingly. Thus the PDU is able to monitor/manage the surrounding connected devices as will be described below, by controlling the outlets.

In order to be able to identify, manage or group the power distribution device(s) the PDUs may comprise a unique identification. Preferably, the ID is installed in the memory of the PDU.

When more than one PDU are used, the PDUs may be connected to each other by the use of network connections and cables. Hence the PDUs preferably comprise network communication means and a processor. Furthermore the PDUs may communicate by means of any kind of wireless communication technique such as infrared light, bluetooth, radio waves, and similar. Since the PDUs may utilise a communication protocol they are able to communicate with each other without interference from a user terminal.

The outlets on a PDU are preferably controlled by an internal Microcontroller. The Microcontroller comprises a processor and therefore the Microcontroller is able to send instructions to relays so that the outlets can be switched on or off. The Microcontroller may be a part of a control unit inside the PDU.

Furthermore the Microcontroller is able to receive instructions over the network so that the processor can send switching instructions to one or more of the outlets.

The Microcontroller may act by itself according to predefined rules set by a super-user or administrator. This is a security aspect in case the PDU is not in contact with an external user terminal. It may also help an administrator to react faster since an administrator may be flooded with information. In these cases the PDU may act by itself in order to avoid any kind of system or device break-down.

The predefined rules are preferably stored in the memory of the PDU so that it is easy to access for the processor and so that the rules are accessible even though the contact to external devices is cut off. The rules may comprise certain thresholds relating to different sensors such as a threshold for the highest/lowest allowable temperature or a threshold for humidity or water level, smoke, current, effect, voltage, and so forth. Thus it is possible to create “windows” wherein the measured values preferably have to be.

Furthermore it is possible to create sub thresholds for sending warnings before an action actually has to be executed. For example if the temperature is not allowed to exceed 35° C., it would be advantageous to have a sub threshold of 30° C., so that a warning is sent before the PDU automatically turns off the relevant outlets when the temperature exceeds 35° C.

The warning may be sent to the user terminal so that an administrator is alerted about the situation and can take necessary precautions in order to avoid a more serious problem.

The difference between an action and a warning is that a warning preferably only sends a message such as a mail, sms or any other kind of electronic message to the administrator informing the administrator about an event that has occurred or is about to occur.

An Action on the other hand does not only send a message such as a mail, SMS, and so forth, to the administrator it may also switch one or more of the outlets to On or Off depending on the state of the outlet and on the event that has occurred and depending on what type of device is connected to the outlet.

Configuration Software—User Interface

An administrator may control the PDUs by using an interface specially designed for this purpose. The user interface may be accessed by use of a user terminal such as a computer, mobile phone, PDA or any other kind of electronic device that is able to access the Internet or local computer networks and to display information on a display.

Preferably the user interface comprises a main form further comprising six different panels. The panels may be as follows:
A menu panel; preferably comprising the functions in the icon list but also other functions such as: File, Edit, View, Tools, Message, Help functions, etc.
An Icon list panel; that is a visual navigation control for the most basic functions. The icon list may comprise buttons such as a PDU button, an outlet button, a sensor button, a warnings button, an action button, a Rescan button, an Add PDU button and a Backup button.
A list control panel; preferably comprising data retrieved from XML files. The list control panel may display many different views, however as a default view the PDU view may be chosen, (see user interface section below).
Property box panel; may display data relating to an entity chosen in the list control panel. For example if a certain PDU is chosen in the list control panel the data relating to the outlets of the chosen PDU may be shown in the property box panel. However the property box may show many different views such as sensor view, user view, up sequence view, down sequence view, network view, etc.
Action/warning log property panels; may display warnings/actions relating to a specific outlet or PDU. An administrator is able to change the properties of the warning/action, this may be done by filling in a configuration form that appears when clicking on the warning or action.
Drag and drop panel; by dragging a column header here it is possible to group that column in the list control panel. This may be done in one or more steps. For example, first an administrator wants to group the information by server center, thus what server centers do exist, and what do they contain. Then the administrator may want to further structure the information by making a sub group of for example the racks in the server centers. Dragging the header “rack” to the drag and drop panel may do this. In this way an administrator is able to obtain a good overview of the systems and the devices connected to the outlets of the PDUs.

Each panel may comprise one or more elements such as any of the blocks retrieved from the XML file.

Thus the user interface has a display function so that an administrator is able to display the network devices according to a chosen group. Thus if the administrator chooses the group “email servers” all the PDUs and outlets connected to email servers will be displayed, also information about the email servers can also be displayed.

Furthermore the user interface may comprise a grouping functionality for the network devices being connected to the outlets of the PDUs. By this function an administrator is able to assign one or more of the network devices to at least one specific group. For example the devices may be grouped into a printer group, a mail server group, a customer group, printers on first floor group, scanners on second floor group, etc., this is not an exhaustive list, many other grouping combinations may be created.

In this way the outlets to which the network devices are connected can obtain a belonging. Preferably the outlets have a belonging and the belonging may be related to the device that is connected to the outlet.

The outlets on the PDUs will thus have a load that belongs to a group, preferably the system knows which group and which device that is connected to each outlet. This information may be provided during set-up of the PDU.

Thus if an administrator wants to turn the power Off on all printers on the first floor, he/she chooses the group “printers on first floor” and executes the action. Thus the administrator does not have to know the actual physical location of the power switch and related outlets since this is taken care of by the system.

Furthermore the outlets may belong to a mode such as “night mode” or “day mode” or “weekend mode”, etc. In this way the PDU system is able to control electrical devices in for example a company so that when the weekend comes, the electrical devices are switched On or Off preferably in a controlled manner.

By using the interface as described above an administrator is able to navigate quickly and easily between different display panels/windows relating to at least one of the following type of panels/windows: icon list/view, Outlet list/view, Sensor list/view, warning list/view, action list/view, Rescan list/view, Power distribution device (PDU) list/view, etc.

The list/views are preferably an actual list or view of the functions described above.

Creating a Database Comprising Devices—Configuration

As described earlier the present invention provides a method for creating a database comprising entities such as PDUs and their outlets, wherein the outlets may be assigned a belonging (attribute). Preferably the database is a relational database, however, the data in the database may be structured in any other way.

The belongings may be used in order to define and structure outlets so that it may be possible to obtain a map of the network. This may facilitate the work for a network administrator since he/she can easily overview and manage the system.

The method may comprise the step of creating a wallet file, preferably the wallet file comprises logins and/or passwords to the devices (PDUs) connected to the network. By having this wallet file an administrator does not need to know all the passwords and logins to the power distribution devices. This further facilitates the user-friendliness of the system for an administrator.

Since the wallet file comprises secure information it is preferred that the file is encrypted in order to make it harder for hackers or other fraudulent persons to access the file.

In order to find devices to add to the database, the method preferably comprises a step wherein a message is sent from the new devices (PDUs) to the user terminal upon a request sent from the user terminal. Hence, the configuration software in the user terminal may send a request signal asking for new devices. When a PDU receives the signal it answers back by sending an acknowledgement message. This message sent from each new PDU preferably comprises an XML file that will be described later in this document. The XML file briefly describes the structure of the PDU from where it was sent.

However, preferably any PDUs may send a message to the user terminal upon a request sent from the user terminal. The request signal may be sent to a specific PDU and/or it may be sent to a group of PDUs and/or it may be sent to all PDUs.

The XML file may be amended at the user terminal according to a set-up procedure wherein the blocks in the XML file obtain data, such as data relating to the devices that will be connected to the outlets of the PDU.

Since it is important to have a fresh and up to date map of the system a scanning for new devices in the network may either be executed manually or automatically at start-up of the system, or when a user logs on to the user interface.

As described earlier, the database may comprise information about the PDUs and the outlets. One important feature is the belonging that may be assigned to each outlet. The belonging preferably is defined as relating to at least one of the following classes:
type of device; it may be necessary for an administrator to assign “a belonging” to an outlet that describes what kind of device that is connected to the outlet. By doing this it may be possible to manage all devices of a certain type, such as email servers, bilge pumps, printers, and so forth.
location of the device; it may be necessary for an administrator to assign “a belonging” to an outlet that describes the location of the device connected to the outlet, such as first floor, or geographically in different countries or cities such as Tokyo, Copenhagen, etc.
functionality of the device; it may be necessary for an administrator to assign “a belonging” to an outlet that describes the function of the outlet or the device connected to the outlet, such as empty room, heat room, inflate, and so forth.
owner of the device; it may be necessary for an administrator to assign “a belonging” to an outlet that tells who owns the device that is connected to the outlet, for example a customer such as a company, and so forth.
user defined fields; it may be necessary for an administrator to assign “a belonging” to an outlet that describes a user specific function/device, therefore it is possible to use user defined fields for this purpose.

The preferred function of the belongings is to make it possible for an administrator to structure the outlets in the system. Thus the administrator may create the belongings, therefore the administrator should create and add the belongings to outlets with great care and consideration.

Furthermore the creation of the database may comprise a step of contacting devices that are located on external networks. In these cases the request signal sent from the user terminal may not always be able to arrive at the new device since the device may be located behind firewalls, etc. Therefore, the method may further comprise the step of contacting devices on external networks by using the IP address or domain name of the device.

Each device (PDU) stored in the database preferably has a record, the record may be used for structuring the information relating to the devices.

The record may comprise at least one of the following data: MAC address of the device, ip address of the device, name of the device, function of the device, group belongings, location of the device, outlet(s), loads on outlets, description of the device, sensors, etc.

Preferably the record is implemented by using an XML file comprising the necessary tags related to the data described above. However any other kind of data structure may be used to implement the record such as an array, string or list or any combination of these wherein the elements relates to a specific data as described above.

By the present system a systematic way to add and to identify new devices (PDUs) that are connected to the system is provided. Furthermore configuration of each PDU is facilitated since each PDU can be identified with the information in the database and accessed from the user terminal.

In the next section the method of integrating unknown devices will be explained.

Method for Integrating Unknown Devices

According to the third aspect of the invention it relates to a method for collecting and storing data from unknown devices as described earlier.

In the process of finding unknown devices a proxy/transparent layer finds and connects to the devices. The step of connecting to an unknown device may further comprise the steps of: using the usage information stored in the first database for communicating with an unknown device.

The usage information may comprise information on how to communicate and/or instruct the unknown device, thus a protocol for communication. The first database may therefore contain a number of protocols related to different power switches or other network devices.

The usage information preferably relates to instructions for the unknown devices. All devices has some kind of language connected to it in order for for example an administrator to be able to communicate with the device and send instructions to it. This set of instructions may be referred to as usage information.

Hence by using this functionality it may be possible to integrate power switches manufactured by other manufacturers into the system. This facilitates the move towards a more centralised IT organisation.

Preferably the system according to the invention has a first database comprising these instruction sets for all existing power switch products on the market. The database may be online and continuously updated.

In this way the configuration software may always be able to access the database and to retrieve relevant information relating to the concerned device.

Thereafter the configuration software may be able to match its own instructions with the instructions for the “unknown device”. When this is done the software will be able to communicate with the “unknown device” and to store information about the unknown device in a “home database” which may be a database on an online server or on a user terminal by sending a message

Preferably an XML file for the unknown device is created and stored in the database as well.

Method for Controlling PDUs in a Network

As described earlier the present invention further provides a method for controlling PDUs in a network. In the user interface section it is described that an administrator is able to structure and display PDUs and/or the outlets on a display.

Actually an administrator may only be interested in controlling the outlets without knowing where the physical outlet actually is located. The method described herein facilitates this since the outlets preferably are assigned a belonging. Furthermore also the PDU may be assigned a belonging. However in order to obtain a more detailed picture of the system preferably each outlet is assigned a belonging. The belongings may be the same classes as described earlier.

The management of the PDUs may furthermore receive inputs from the surroundings wherein the devices are located. Therefore as described earlier the PDUs are equipped with sensor ports to which sensors may be connected.

The management of the PDUs and outlets may result in controlling the outlets or PDU according to some actions that may be triggered either by input from a sensor/meter or by input from a user such as an administrator. Furthermore the input may also be sent from the devices connected to the outlets or from other PDUs.

The actions whereby the outlets or PDUs may be controlled preferably relates to at least one of the following activities: power on, power off, cycle power, sequence up, sequence down, and user defined power sequence activity.

Thus the method for controlling the PDUs in a network may comprise collecting information from sensors or meters in the system. Comparing the retrieved values with some predetermined threshold values stored in a memory either in the PDU or on a server.

Based on the comparison execute an action or warning that will switch one or more outlets On or Off and/or alert an administrator/user terminal.

A Computer System Comprising PDUs

As described earlier the present invention provides a computer system programmed to display information relating to one or more of the power outlets according to predetermined belongings of the power outlets.

The belongings of the outlets may be chosen from the classes as described earlier i.e. type of device, location of the device, functionality of the device, owner of the device or user defined.

Furthermore the belongings may be related to a type or location of one or more sensors.

In this way it is possible to send instructions from the user terminal to one or more PDUs in the network. It is also possible to send instructions to individual or grouped outlets, according to belongings, in one ore more PDU, wherein the outlet may belong to a specific group.

Furthermore the invention provides a solution wherein it is possible to individually control outlets in a network of PDUs without a control unit since the PDUs are able to act on their own according to rules stored in the local memory.

Moreover by providing a network extender it is possible to increase the number of PDUs in a network.

These and other aspects of the invention will be apparent from and elucidated with reference to the embodiments described hereinafter.

### BRIEF DESCRIPTION OF FIGURES

FIG. 1 illustrates a schematic view of a power switch.

FIG. 2 illustrates a schematic view of the internal structure of the power switch.

FIG. 3 illustrates the Network Bridge in a network.

FIG. 4 illustrates the extension unit of a network.

FIG. 5 illustrates the user terminal.

FIG. 6 is a schematic view of the structure of a user terminal.

FIG. 7 illustrates a power switch network with a single switch.

FIG. 8 illustrates a power switch network with a single switch and a user terminal.

FIG. 9 illustrates a power switch network with multiple PDUs and one user terminal.

FIG. 10 illustrates a power switch network comprising multiple PDUs, one user terminal, and one network extension unit for adding more PDUs to the network.

FIG. 11 illustrates a network wherein the devices use double power sources.

FIG. 12 illustrates a power switch network comprising multiple PDUs and one user terminal wherein the connection between the user terminal and the network is wireless.

FIG. 13 illustrates a top of a rack case.

FIG. 14 illustrates a bottom part of a rack case.

FIG. 15 illustrates a front plate of a rack case.

FIG. 16 shows an embodiment of a front plate.

FIG. 17 shows an embodiment of a back plate.

FIG. 18 illustrates a stand-alone PDU.

FIG. 19 illustrates a controlled PDU.

FIG. 20 illustrates a PDU connected to a network.

FIG. 21 illustrates a second embodiment of an internal block diagram.

FIG. 22 illustrates a first embodiment of an internal block diagram.

FIG. 23 illustrates an internal control unit.

FIG. 24 illustrates an internal circuit (onboard micro-controller).

FIG. 25 illustrates an embodiment of the main window for controlling the system.

FIG. 26 illustrates a typical arrangement of server centres wherein the power switches may be used.

FIG. 27 illustrates a form showing a list generated based on the arrangement in FIG. 27.

FIG. 28 illustrates what happens when the server center element is dragged and dropped in the drag and drop window.

FIG. 29 illustrates second level in the tree structure of the system.

FIG. 30 illustrates a third level in the tree structure of the system.

FIG. 31 illustrates a program start window when wallet file is not present.

FIG. 32 illustrates a program start window when wallet file is present.

FIG. 33 illustrates a listing of found power switches.

FIG. 34 illustrates a set-up window.

FIG. 35 illustrates algorithm for finding switches to be set-up.

FIG. 36 illustrates an embodiment of the icon-line and icons.

FIG. 37 illustrates a window for management of actions relating to outlets.

FIG. 38 illustrates a MAC address used in the present invention, comprising 8 bit family code+48 bit serial Number+8 bit CRC test.

FIG. 39 illustrates a login web interface.

FIG. 40 illustrates a main page of a web interface.

FIG. 41 illustrates a sensor page of a web interface.

FIG. 42 illustrates an action log page of a web interface.

FIG. 43 illustrates the function of the configuration software in relation to own products and alien products.

FIG. 44 illustrates a scheme for communication between software and products.

FIG. 45 illustrates a flow chart for configuration of the system.

Figures are preferably schematically drafted in order to facilitate the understanding of the invention. Therefore other designs that could be drafted in the same schematic way are implicitly also disclosed in this document.

### DETAILED DESCRIPTION OF PREFERRED EMBODIMENTS

Description of the Power Distribution Device (PDU)

The power distribution device according to the invention is preferably a combination between a power switch, a computer and a sensor system mounted within the same housing. The PDU is intelligent, as it is able to act on its own and make decisions depending on inputs.

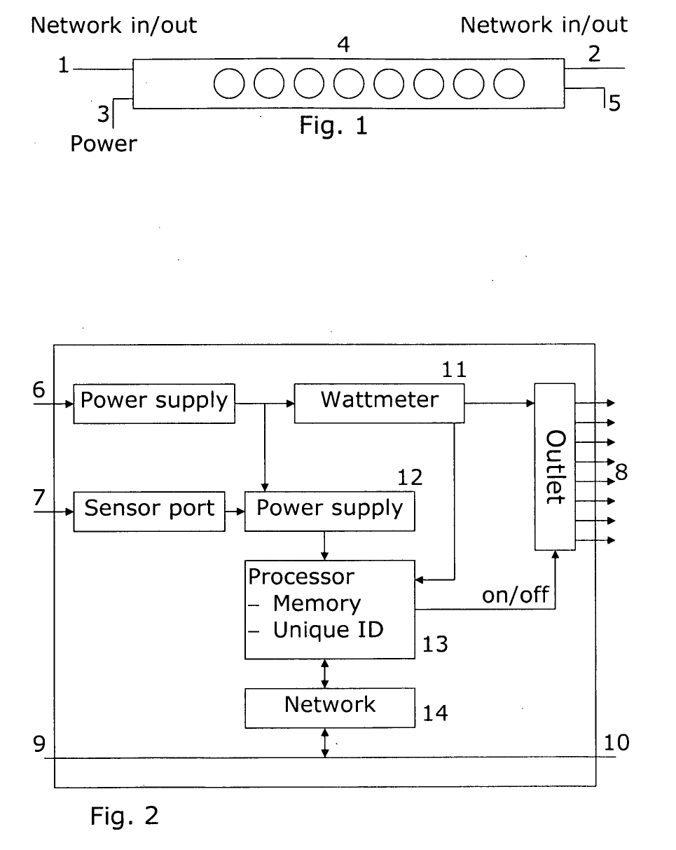

FIG. 1 illustrates an embodiment of a PDU comprising eight outlets. The PDU is able to switch the outlets on and off either by itself based on inputs from for example sensors connected to the PDU 4 via the sensor port 5 or the outlets may be controlled according to settings saved in the memory of the PDU. In a preferred embodiment of a PDU the network connection 2 may be omitted. However the network connection 2 may be used in an embodiment wherein it may be an advantage to “Daisy chain” units.

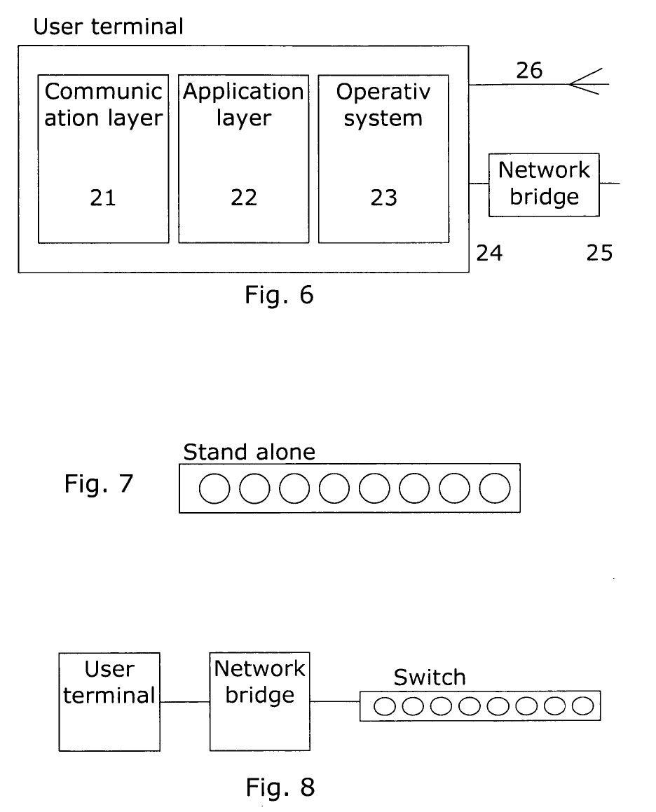

The PDU may be controlled by a user terminal, see FIG. 6, by establishing a communication to the user terminal through the network connection. In this way the PDU may be able to send information regarding the environment wherein it is situated to the user terminal. The information may be related to the devices connected to the outlets or information coming from the sensors.

Preferably each PDU is connected to an external power source in order to receive power that may be distributed to the outlets and also for the internal circuits in the PDU.

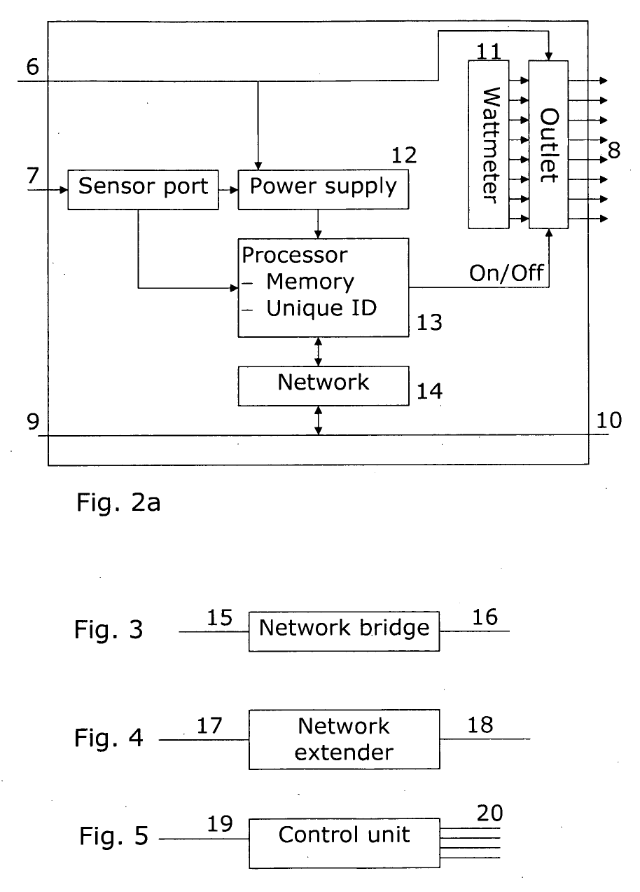

FIGS. 2 and 2a schematically illustrates two embodiments of a PDU wherein the external power source is connected to the interface 6. The PDU may be connected to a network via the network interfaces 9 and 10, hence the network may be extended through one of the interfaces 9 or 10.

Preferably each PDU comprises at least one internal wattmeter 11 and a sensor port 7 which may be connected to the internal Microcontroller 13. The processor is furthermore connected to the network of PDUs so that the PDU is able to send and receive information from the network. Preferably the information is sent from the user terminal or from another PDU.

FIG. 3 illustrates a network bridge that may be used for interconnecting a computer communication port to the network of PDUs. The bridge may be used for connection the PDU network to a user terminal. The user terminal can be connected to the bridge via port 15 and the bridge may be connected to a PDU via port 16.

Preferably the Network Bridge is an interface between an external network and the internal system in a PDU. Thus the Network Bridge may be an internal control unit as will be described later in this document.

Thus in another embodiment the Network Bridge may be a base station for mobile communication, a modem or any other kind of intermediate device.

FIG. 4 illustrates a network extender unit, which may be used for extending the number of PDUs connected to each other, hence increasing the size and range of a PDU network. The network extender may be connected to a PDU or PDU network via port 17 and to a network via port 18.

The network extender may facilitate the connection of for example intranets on different locations. Thus the network extender may be a base station or it can also represent the Internet. In this way it is possible for for example a company having a distributed organisation to centralise its IT department.

However, in the preferred embodiment the network extender may be omitted.

FIG. 5 illustrates an embodiment of a user terminal for PDU network. The user terminal may be connected to the PDU network via a network bridge connected to port 19. Depending on the embodiment of the user terminal it may further comprise other ports 20 that may be connected to other external systems/apparatuses.

Furthermore the user terminal may use other technologies for connecting to the PDU network for example wireless technology such as, infrared light, blue tooth, GSM, 3 G or any other wireless or wired communication technology.

Thus the user terminal may preferably be a computer, mobile phone, PDA or any other device able to communicate with other devices and to display information to a user.

FIG. 6 schematically illustrates a user terminal. The user terminal may be connected to a network bridge via port 24. Information that enters port 24 from the Network Bridge is received by the operation system 23 and is forwarded to the PDU communication layer 21. The PDU system may in this way be controlled via the application layer 22 that is able to send and receive information about the PDU via the communication layer. Since the communication layer preferably is connected with the operative system, the application layer is able to receive and send information and to react upon information received on port 26 that may be connected to the operative system of the user terminal.

In a second embodiment port 24 and 26 may be integrated into one port.

FIG. 7 illustrates an embodiment of a PDU that is a stand-alone device. In this set-up the PDU may either by it self switch the outlets on or off depending on input on the sensor port, or from the wattmeter. It may turn the outlets on or off depending on settings/rules stored in the internal memory, thus input may be compared with certain thresholds stored in the memory.

FIG. 8 illustrates an embodiment of a PDU network as described in FIG. 7 wherein a network bridge and a user terminal has been added to the system. The network bridge and user terminal may extend the functionality of the system since the PDU is now able to communicate with the user terminal.

By this arrangement the PDU is able to turn the outlets On or Off by itself, based on input on the sensor port, wattmeter, internal setting/rules in the memory. For example may a controlled start-up sequence or, controlled down sequence be executed.

Furthermore the PDU is able to send information to the user terminal and the user terminal is able to send instructions to the PDU in order to control the PDU.

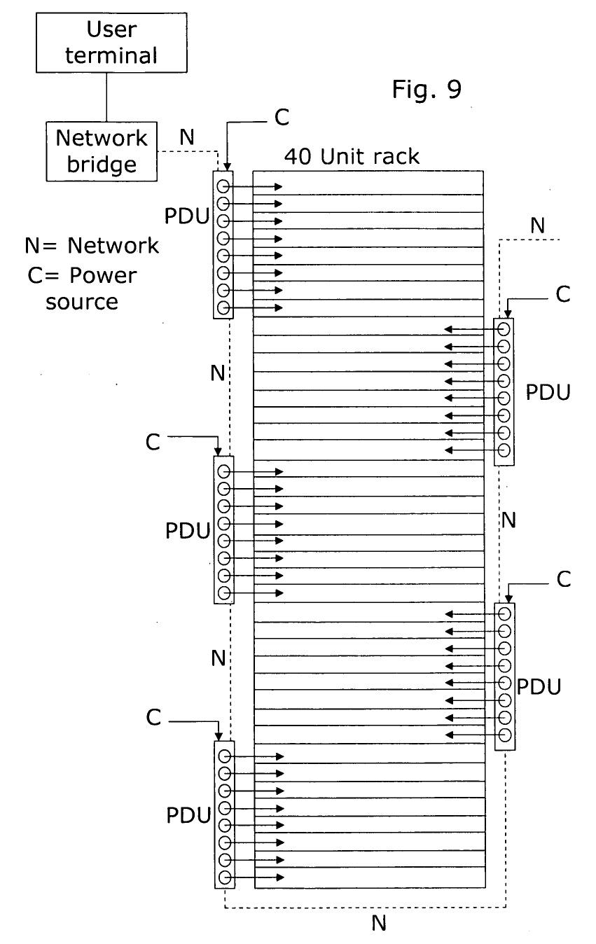

FIG. 9 illustrates a PDU network described in FIG. 8 wherein the network has been extended with more PDUs. It may be possible to connect many PDUs to directly to the network bridge. The network may further be extended by adding a network extender.

As described in FIG. 8 the PDUs are able to react on inputs on the sensor port and/or on instructions from the control unit. The major difference the arrangement in FIG. 9 compared to the one in FIG. 8 is the number of PDUs and thus the possibility that a sensor input on one PDU may influence other PDUs in the network. This can be done either by sending the information over the PDU network to the user terminal so that the user terminal can instruct the other PDUs, or the information may be sent to the other PDUs directly over the PDU network.

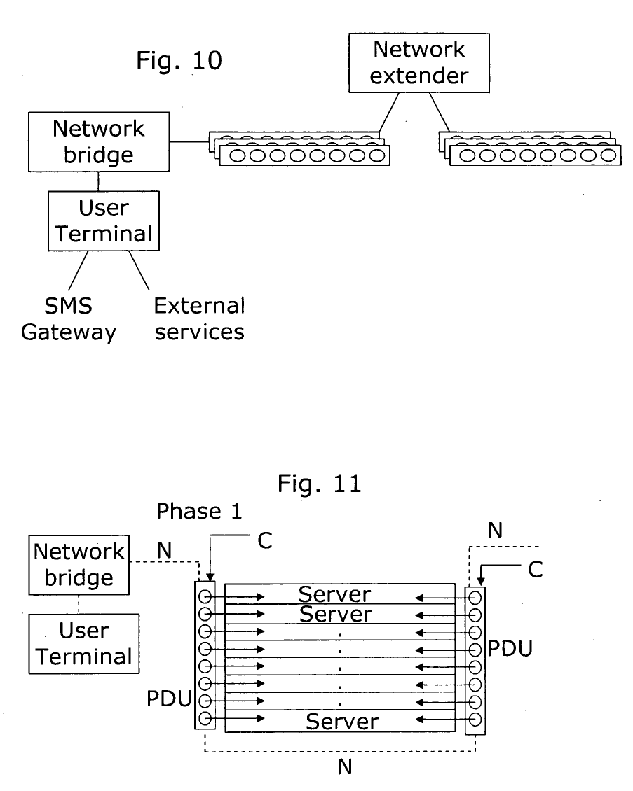

FIG. 10 schematically illustrates a PDU network as described in relation to FIG. 9, however the network in FIG. 10 further comprises a network extender showing how the PDU network could be extended.

There may be a limit for the number of PDUs connected to a network segment. However if a user wants to add more PDUs he/she can do this by using a network extender that makes it possible to add more network segments.

FIG. 11 illustrates an example of a system configured to deliver power to electrical devices having double power inlets. Preferably two PDUs are used wherein the PDUs are synchronised to turn the power on or off at the same time. Outlet no 1 on the first PDU may be related to outlet no 1 on the second PDU, the same goes for outlet no 2, etc.

The PDUs may comprise internal timers that are synchronised or the PDUs may be centrally controlled by a signal sent from the user terminal.

By having this arrangement it is possible to reduce the risk of power failure to a server since the PDUs may be connected to different power sources.

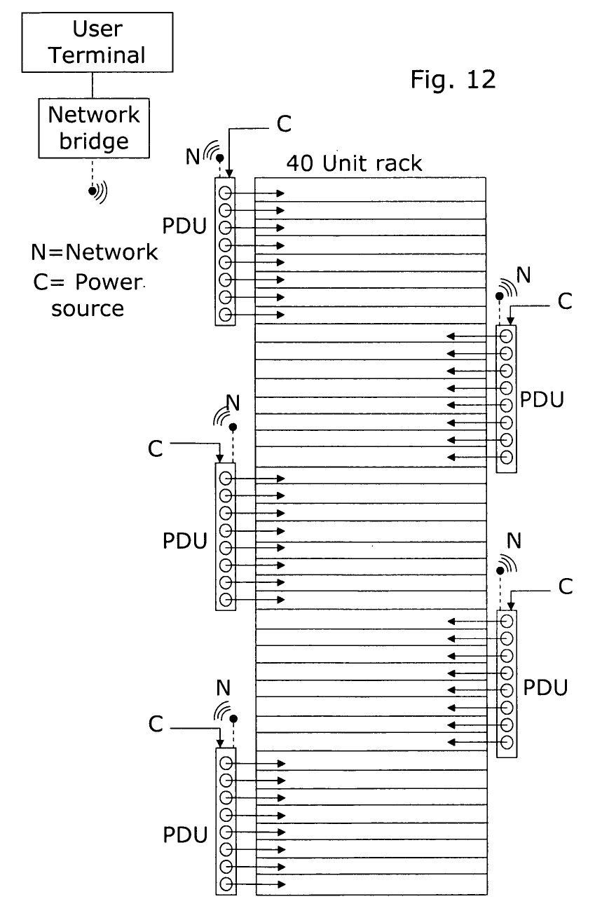

FIG. 12 illustrates the same system as in FIG. 9, however in this embodiment the wired communication is replaced with wireless communication.

Exterior of the PDU

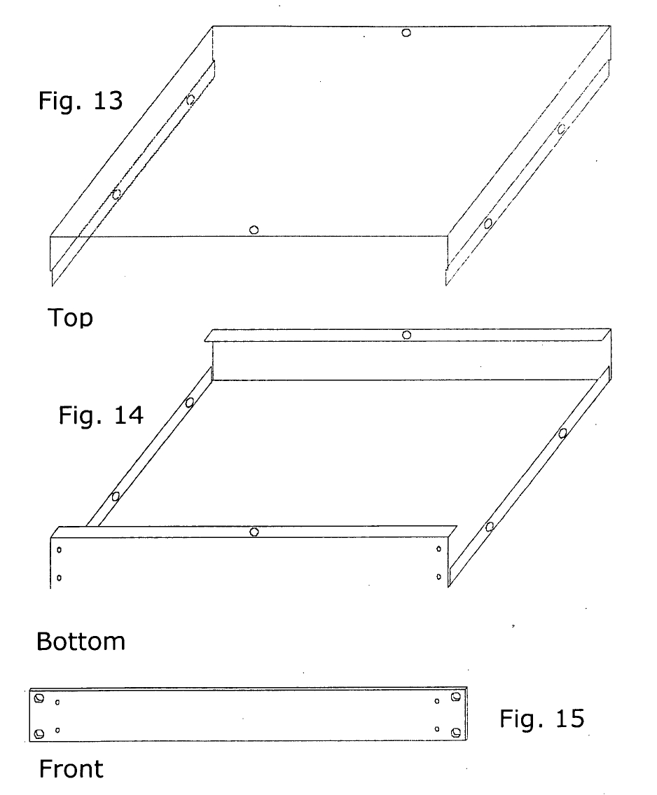

The electronics in the PDU are preferably mounted in a casing as shown in FIG. 13-15. In order to fit into the environment wherein the PDU may be used the height of the casing is preferably one rack-unit (4.5 cm), the width is 45 cm and the depth is 15 cm. However the size is not important, as long at the casing is easy to handle and is able to keep the electronics inside at a suitable temperature.

Front Plate

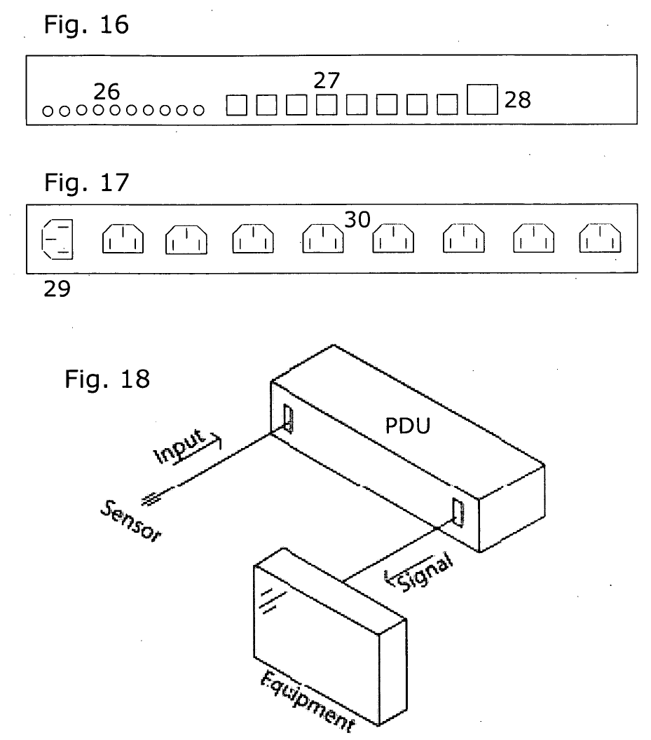

On the front plate, shown in FIG. 16 there are light indicators 26, which indicate if the device is connected to a power source and indicate the status (On/Off) of the outlets on the PDU. Furthermore the front plate of the PDU may comprise 8 sensor ports 27 to which up to 30 sensors can be connected, and an Ethernet connection 28 so that the PDU can be connected to a network. The Ethernet connection may also be used for connecting more PDUs if more outlets and/or sensors are needed.

Because of the small weight it is not necessary for the casing to be equipped with handles in order to facilitate the handling of the device.

Preferably there are mounting holes in the front plate so that the PDU can be mounted into a rack.

Furthermore the front plate comprises 10 holes for positioning of LEDs, in this way a user is able to see the status of the PDU by simply looking at the PDU.

The LEDs indicate as follows (from left to right):
1 LED, indicates that the PDU is connected to a power source
1 LED, may be used as an indicator that is dependent on the software, thus the function of the LED may be defined by a user of the system,
8 LEDs, indicate whether the power is switched ON or Off on the outlets.

As mentioned above there are some other connections located on the front plate of the PDU, the connections may be as follows:
Network port, preferably an Ethernet port to which the network may be connected,
Sensor port, preferably comprising a power-limiting unit such as a fuse.

Function of the Front Plate

In the preferred embodiment, the front plate fulfills the following functions.

The preferred functions of LEDs position from left to right:
position one, LED indicates that the PDU is connected to a power source,
position two, LED is an error indicator
position 3-10, LEDs indicating if power is ON or OFF on the outlets

Back Plane

On the back plane, shown in FIG. 17 there may be a power inlet 29 for supplying the PDU and its outlets with power. In the preferred embodiment there are eight outlets 30, which may be controlled by the PDU. However in a second embodiment the PDU may comprise more outlets, such as 16 or more.

Function of the PDU

Preferably the PDU has two primary functions. The first may be to function as a power control unit and the second may be to function as a data-collecting unit. Furthermore the PDU may also function as a Prefailure and Disaster Recovery unit.

Power Control Unit

As a power control unit the PDU preferably controls the outlets on the back plate by switching them On or Off. Power may be controlled individually for each outlet, controlled in pairs, controlled in groups or in a sequenced up/down sequence.

Each outlet is equipped with a meter so that the power consumption for each device connected to the relevant outlet may be calculated. Hence the PDU may be used as a device that physically controls devices connected to the outlets of the PDU.

Data-Collecting Unit

The PDU comprises a sensor bus, to which up to 30 sensors may be connected. Preferably each sensor has a unique ID which make the PDU able to identify and to communicate with each sensor.

The communication protocols used in the present invention do not limit what type of sensors that may be connected to the PDUs. Therefore, sensors may be developed according to very specific demands. Hence the PDU may be used as a pre-failure unit that alerts errors before they have serious consequences.

Prefailure Unit

The PDU may function as a prefailure unit by sending alerts to an administrator or by taking actions according to input from the surrounding system such as from sensors, other PDUs, other devices connected to the network, etc.

In this way it is possible for the PDU to predict and detect bad trends in the system and to execute necessary actions in order to avoid a system failure.

Disaster Recovery Unit

Furthermore the PDUs may function as a Disaster Recovery Unit. For example if an earthquake has occurred and power failure has caused many electronic devices to go down, the PDU may be able to start up the systems in a controlled way and to send status reports to an administrator for example if the PDU cannot solve the problem by itself.

Examples of Implemented PDUs

The PDU may be implemented as:
a stand-alone device: One PDU that is able to act on its own,
a controlled stand-alone device: One PDU that may be controlled by a computer,
network controlled devices: Two or more PDUs connected in a network.

Stand-Alone Device

An example of a stand-alone PDU is shown in FIG. 18. This arrangement comprises one PDU without a network connection. Sensors may be connected directly to the PDU.

The stand-alone PDU is preferably controlled by a program installed in the memory and executed by the internal processor. Hence decisions may be made based on for example sensor input or power consumption on the outlets. In this way the PDU is able to act independently by turning the outlets On/Off.

For example if a cooling system is connected to one of the outlets of a PDU, a sensor may send an input signal to the PDU, wherein the signal relates to a value representing the measured temperature. The input signal is compared to predetermined thresholds stored in the memory of the PDU. If a certain temperature limit has been exceeded, the PDU may turn the power on to the outlet to which the cooling system is connected. Another example could be to start a pump if a sensor sends a signal that water is on the floor, etc.

Hence a signal from a sensor is treated in the processor according to rules/instructions preferably stored in the memory and when a certain rule/instruction is not obeyed an action is triggered. In this case the action may be to turn the power On or Off for a certain outlet or group of outlets or a combination of On and Off instructions to different outlets.

Controlled Stand-Alone Device

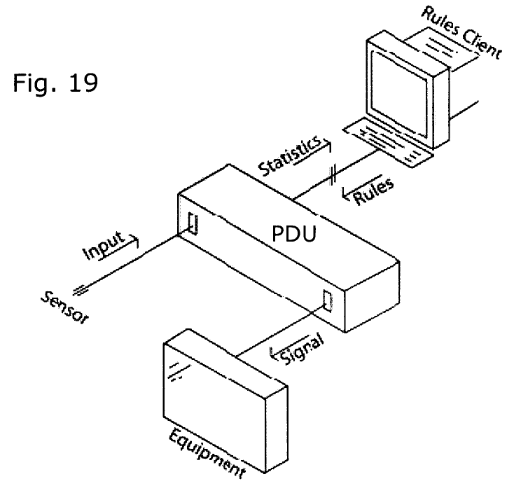

An example of a controlled stand-alone device is shown in FIG. 19.

In the controlled arrangement the PDU is preferably connected to a network such as an Intranet, LAN, WAN the Internet, etc. A user terminal such as a PC or other electronic device is preferably also connected to the network so that it can communicate with the PDU in order to send instructions and also for receiving information from the PDU. Furthermore the PDU may also be able to send information/instructions to other PDUs also connected to the network.

Since the sensors are connected to the sensor bus in the PDU the information collected by the sensors may be sent to the user terminal or other PDUs through the PDU.

The PDU may independently react on the inputs from the sensors or power consumption measured at the outlets, or the inputs may be forwarded to the user terminal so that the user terminal is able to send instructions via the network connection back to the PDU for controlling the outlets.

Preferably input from the sensors and power meters may be interchanged between the PDU and the user terminal. In this way it is possible to record the data and make statistical calculations and analyses of the:
environment wherein the PDU is located,
devices connected to the outlets of the PDU system,
of the outlets connected to one or more PDUs.

Furthermore it is possible to make decisions based on the input and to execute a suitable action or warning based on the decision made.

Actions and warnings may alert a system administrator or may solve the problem by turning an outlet off and sending a report about the event to for example a system administrator.

PDU Connected to a Network

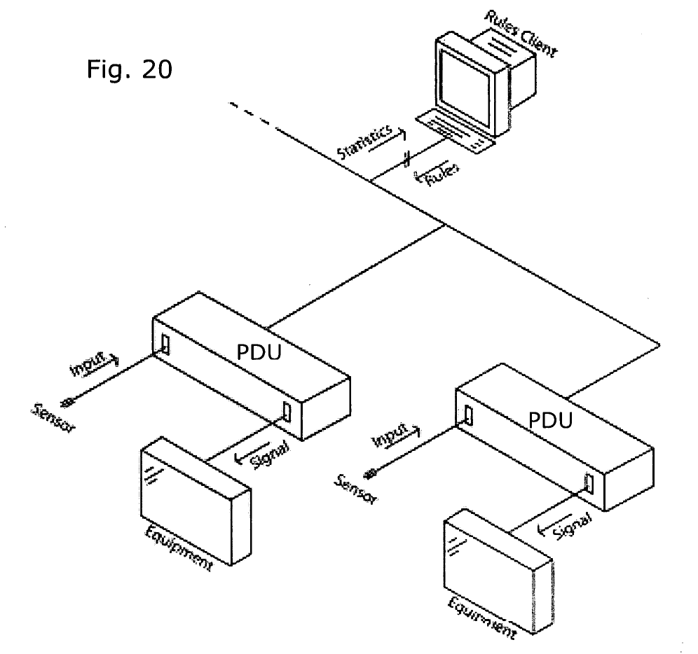

An example of a PDU connected to a Network is shown in FIG. 20.

It is possible to connect a plurality of PDUs to a network by using the network interfaces. Furthermore a user terminal such as a supervision computer may be connected to the network.

In this arrangement the PDUs may act independently based on inputs from their sensors and meters and based on the rules/instructions stored in the internal memory, as described earlier.

Furthermore the PDUs may be controlled by the user terminal, which has the role of a supervision unit via the network. Data from the sensors or meters may be interchanged between the PDUs and the user terminal. The collected data may be stored in a database and used for statistical purposes and other analyses of the system.

In this embodiment it is possible to create and execute an action/reaction in a second PDU based on collected information in a first PDU, such as input from sensors/meters, etc.

In this way a network of PDUs is created that makes it possible to collect information from sensors, meters and supervision units, etc. and to react on the input either manually or automatically. For example a sensor may send an alert via one PDU about a fire in one room, this event may trigger another PDU to turn one of its outlets On or Off in order to extinguish the fire.

Interior of the PDU

The PDU preferably comprises an internal control unit (ICU) connecting the PDU to the Internet and one microcontroller controlling the watt/current meters, relays (outlets) and sensor bus.

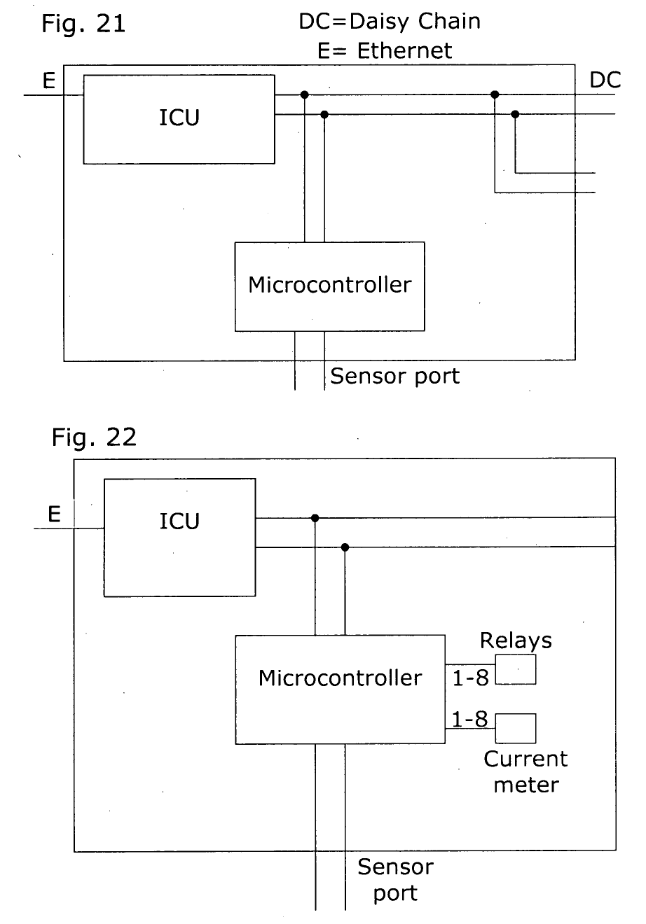

One embodiment of the internal architecture can be seen in FIG. 21, a second embodiment can be seen in FIG. 22.

Sensor-Port—1-Wire

The sensor-port may be of the 1-wire type, this makes it possible to connect many sensors to a bus.

The technology uses one wire plus ground in order to achieve transaction of information and electricity. Preferably each device (sensor) comprises a unique digital address.

Internal Control Unit—ICU

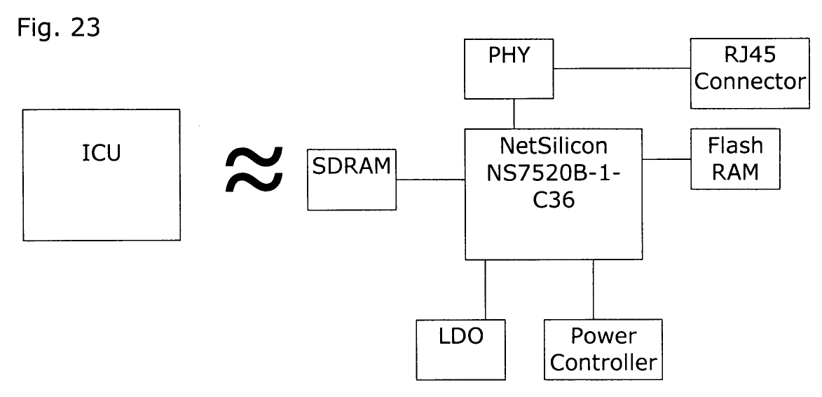

Preferably the internal control unit is an embedded device server such as a Digi Connect me, the unit comprises a microprocessor and the internal architecture can be seen in FIG. 23.

An embodiment of a PDU comprising an ICU unit can be seen in FIG. 21 or 22.

However any kind of internal control unit can be used as long as it is able to perform necessary tasks.

Internal Microcontroller

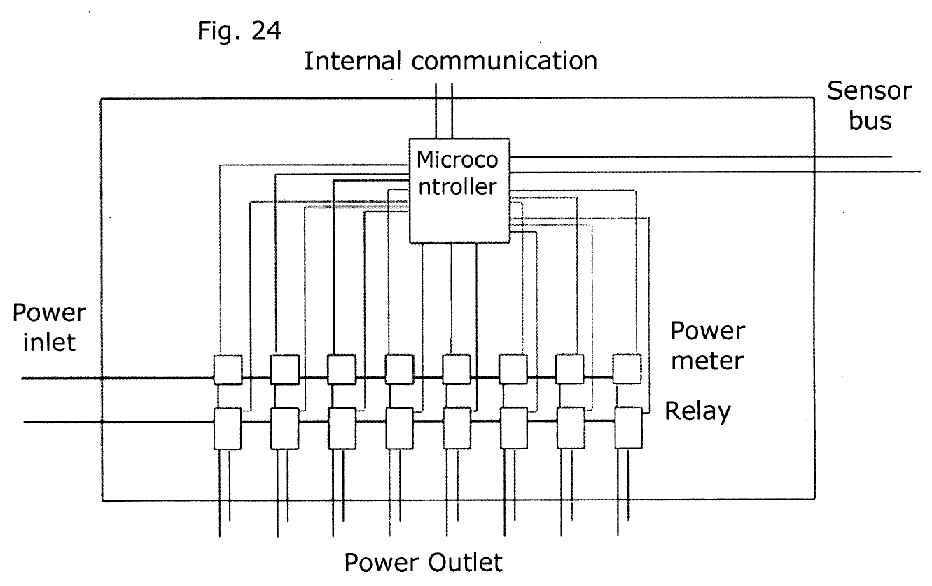

Preferably a Microcontroller comprising power meters, relays, power outlets, sensor inputs and communication connections, may be used as an onboard Microcontroller, such as an Atmel. The internal architecture can be seen in FIG. 24.

However any kind of internal microcontroller can be used as long as it is able to perform necessary tasks

The Internal Control Unit (ICU) and Microcontroller

When internal communication occurs preferably the communication is serial. If the ICU unit questions the Microcontroller it may send a data block as described below to the Microcontroller unit. The Microcontroller executes the operation and replies with a data block. Below follows a more detailed explanation of the preferred embodiment of block format and transactions.

Block Format

There are four different block sizes with the following format:

Command block, 4 bytes total.

| LEN | ADD | CMD | SUM |
|---|---|---|---|
| Length | Address | Command | Checksum |

Byte block, 8 bit of data, 5 bytes total.

| LEN | ADD | CMD | D1 | SUM |
|---|---|---|---|---|
| Length | Address | Command | Bit 0 . . . 7 | Checksum |

Word block. 8 + 8 = 16 bit of data, 6 bytes total.

| LEN | ADD | CMD | D1 | D2 | SUM |
|---|---|---|---|---|---|
| Length | Address | Command | Bit 0 . . . 7 | Bit 7 . . . 15 | Checksum |

2 byte block. 8 + 8 = 16 bit of data 6 bytes total

| LEN | ADD | CMD | D1 | D2 | SUM |
|---|---|---|---|---|---|
| Length | Address | Command | Bit 0 . . . 7 | Bit 0 . . . 7 | Checksum |

Longint block. 4*8 = 32 bit of data two's complement, 8 bytes total.

| LEN | ADD | CMD | D1 | D2 | D3 | D4 | SUM |
|---|---|---|---|---|---|---|---|
| Length | Address | Command | Bit 0 . . . 7 | Bit 7 . . . 15 | Bit 16 . . . 23 | Bit 24 . . . 31 | Checksum |

4 byte block. 8 + 8 + 8 + 8 = 32 bit of data, 8 bytes total

| LEN | ADD | CMD | D1 | D2 | D3 | D4 | SUM |
|---|---|---|---|---|---|---|---|
| Length | Address | Command | Bit 0 . . . 7 | Bit 0 . . . 7 | Bit 0 . . . 7 | Bit 0 . . . 7 | Checksum |

LEN - Length.
The length of the block - 1. First byte has number 0.
ADD- Address.
Controller address. Set to 0 if broadcast command.
CMD - Command/acknowledge.
Command or acknowledge number.
D1 . . . D4 - Data fields
Block data if any.
SUM - Checksum
LEN + ADD + CMD + D1 + D2 + D3 + D4 truncated to 8 bit.

Below follows an example of a transaction in the system:

Master transmits:

| Master | LEN | ADD | CMD | D1 | D2 | D3 | D4 | SUM |
|---|---|---|---|---|---|---|---|---|
| Tx bytes | 7 | 10 | 26 | 16 | 39 | 0 | 0 | 98 |

Length 8 − 1 = 7
Address 10
Commands: 26 (Set new position)
Data fields: 16 + 39*2⁸ + 0*2¹⁶ + 0*2²⁴ = 10000
Checksum: 7 + 10 + 26 + 16 + 39 + 0 + 0 = 98

Slave (Controller) responds:

| Module (Slave) | LEN | ADD | CMD | SUM |
|---|---|---|---|---|
| Rx bytes | 3 | 10 | 27 | 40 |

Length 4 − 1 = 3
Address 10
Acknowledge: 27 (New position set)
Bit fields: N/A
Checksum: 3 + 10 + 27 = 40

In this example the ICU is the master and sends a package to the slave (Microcontroller). The data block has 7 in length and the module that should react to the command is called 10. The command that is to be executed has number 26 and data for the commando is added as D1-D4. The data block preferably ends with a checksum.

Module number 10 reacts on the data block as long as the size of the package and checksum is correct. Hereafter the commando is executed and an answer/reply is sent back in form of a datablock that preferably has the length of three. This package preferably comprises information about which module is answering and an acknowledgement of the received commando and checksum.

The above is an example of a module having number 10, however it could also be a module having number 9 or another number. In this way it is possible to connect more microcontrollers onto the same communication line.

PDU State and Functions

The PDUs may hold different states depending on how far the process of installation or configuration has advanced. Below follows descriptions of different states that the PDU may hold.

State 0—“Out of the box”

State 0 may relate to an un-configured or configured PDU. If the PDU is un-configured the LEDs on the front plate may indicate this.

Preferably state 0 may sequences all outlets up with a time interval between each outlet. In this way the PDU can be used as a simple power switch until it has been configured.

By using configuration software for the system the PDU is “discovered” and “configured”. If the PDU is configured the LEDs on the front plate may indicate this in some way.

Preferably when power is connected to the PDU, the ICU starts and looks for earlier startups of the PDU. Thereafter the ICU calls the Microcontroller for instructing it to turn on or off the LEDs.

State 1—“Mounted in Rack”

As default the relays inside the PDU could be switched off, so that it may only be turned on by use of the interface-software. Hence when power is connected to the PDU the ICU looks for earlier upstarts, preferably all outlets are switched to Off.

This state may be identical to state 3. In principle, it is a start-up wherein there is no information in the ICU about the start sequences.

State 2—“Switch off/Sequence Down”

It is possible to instruct the PDU to switch off all outlets, however as there is preferably no physical button for switching On/Off the outlets, the PDU is able to switch the outlets On or Off by itself by controlling the relays via the Microcontroller.

A Central Network Switch CNS or event may request the ICU to perform a sequence down. The ICU thereafter contacts the Microcontroller for switching off the outlets according to a sequence down order.

State 3—Brownout “Switch On/Sequence Up”

In this state power has been turned off due to power failure, overloaded fuse, etc.

The circuitry checks if a brownout has occurred and the outlets are switched On according to specifications from the ICU or other internal commandos.

State 4—Non Brownout/Reset ICU/Microcontroller

In this state the ICU/microcontroller has been reset, but an internal reset should not alter the state of the power outlets.

Therefore a watchdog or the Microcontroller resets the Microcontroller/ICU or both. When the Microcontroller or ICU is reset the outlets shall preferably hold state.

State 5—Watchdog

If the Microcontroller or ICU fails, the watchdog in the microcontroller is activated and restarts the Microcontroller, ICU or both.

State 6—Switch On Based on Control Box/Sensor

The ICU preferably instructs the Microcontroller to switch an outlet On. This may be done in the same way as described in state 2.

State 7—Switch Off Based on Control Box/Sensor

The ICU preferably instructs the internal electronics to switch an outlet Off. This may be done in the same way as described in state 2.

State 8—Check Current Meter

The ICU may ask the Microcontroller to read the value on one or more of the current meters connected to the outlets. The Microcontroller sends the information about the power consumption back to the ICU.

State 9—Read/Write and Forward Commandos to Sensors

The ICU is preferably not connected directly to the sensors, however the ICU may ask the Microcontroller what units are connected to the outlets and hence is able to send and receive data to/from the sensors via the Microcontroller.

When the function is requested the Microcontroller scans the sensor bus for connected units.

Functions

This section describes some of the functions that the PDU may perform and the means for performing these functions.

Power Measurement

Preferably the PDU is able to measure power consumption on each outlet by the use of internal meters in the Microcontroller unit.

Power Bus

By using a power bus and a switchmode PSU (Power Supply Unit) the PDU is able to handle power preferably between 90-250 VAC. However the PDU may be designed to handle stronger or weaker power depending on its implementation.

Sequencing UP—(Brownout/Power)

At start-up the outlets are preferably switched Off, this is the default relay state. Thereafter the microcontroller may switch the outlets On or Off based on information stored in the memory and based on the brownout-detector.

The sequence may change depending on the devices connected to the outlets, some devices have to be started before other devices, some devices have a higher power consumption than others, etc.

Sequencing Down

Based on instructions from other devices in the network or from the memory in the PDU the outlets may be switched Off according to a predetermined sequence, decided by a user or system provider.

Metering

Unit whereby it is possible to read the power consumption, preferably the unit is able to inform about the real power consumption even though the Volt may vary between different values such as between 90-250 VAC. The meters may be Volt meters, current meters, ampere meters, etc.

Daisy Chain-Port

In one embodiment the PDUs may comprise a daisy chain-port for daisy chaining PDUs.

Sensor Port

The sensor port is preferably a 1-wire port since it is possible to address specific units connected to the port by using IDs. However other types of ports may be used for connecting sensors to the PDU, these will be obvious to a person skilled in the art.

Mac Address

Preferably the ICU has an integrated MAC address which may be used for identifying the ICU on a network

Network Protocols

The PDUs may function with a number of different protocols, below follows a list of a few of them:

IPV4/IPV6/TCP/UDP/SNMP DHCP and TFTP, UDP, ICMP, PPP, IGMP, HTTP—Web, POP3, SMTP—Email Services, FTP—File Transfer, SNMP, Active Directory, Telnet, SSL 3.0/TLS 1.0 with strong encryption—DES, 3DES, AES, SNTP, DNS, SNMPv2, LDAP, PPP, DHCP, BOOTP, RARP, ARP/Ping

Watchdog

Is a function that provides the possibility for the system to restart the internal electronics when the PDU has been shut-down of some reason or if any other event occurs that demands a restart of the PDU.

The outlets may not be effected by the watchdog since they preferably should hold state, thus they should not change state even if the electronics inside a PDU fail.

Software

Configuration Software

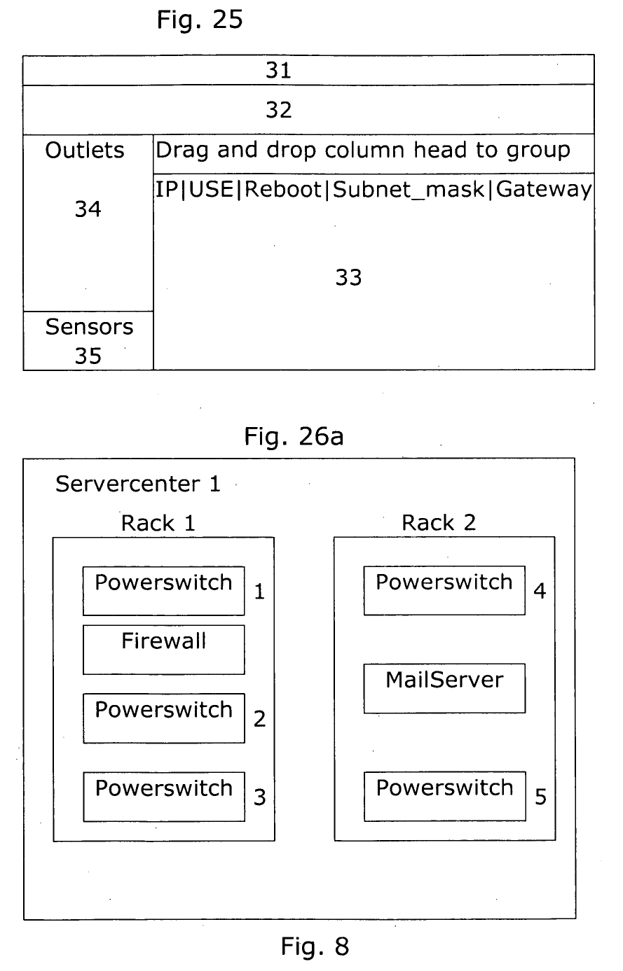

FIG. 25 illustrates an embodiment of the main form for the user interface, which has been, developed in order to provide a user-friendly interface for a user. The window is built up so that it provides an intuitive and logical access to different PDUs and their outlets. Thus it makes it very easy for a new user to learn to use the configuration/control software.

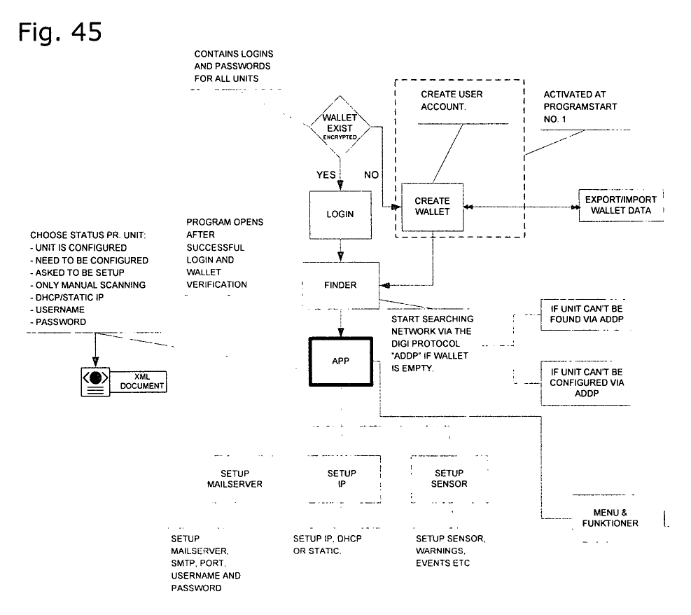

FIG. 45 illustrates a flowchart of the configuration software. The application program comprising the user interfaces (menus and functions) for controlling the system starts after successful login and wallet verification.

In the first step the software checks whether there exists a Wallet file or not. If it does exist it continues on to the login function. If a successful login has been achieved, the software moves on to a “finder” function. In this step the program searches the network for new devices.

In the first step however, if a wallet file does not exist, the software continues to the “create wallet” function. In this step a new user account may be created, or the function may export/import wallet data from external wallets.

After successful login, wallet verification and after the finder has performed a search, the actual application program opens. Preferably the application program opens the main form as will be described later.

One important feature of the configuration software is that a user by using the software is able to copy a certain setting for a first PDU and install the same setting into other PDUs in the network. This feature may save a lot of time for a user since he/she does not need to configure each PDU from the start. Instead he/she can copy the setting and then make changes if necessary.

Protocols

Since the PDU comprises a computer, an Ethernet port, tcp/ip and udp options there are almost no limits as to how and with what the PDU may communicate on the network. Below is listed a few protocols that the software in the PDU may support:

Basic Protocols, IPV4 IPV6, TCP, UDP, ICMP, PPP, IGMP, HTTP—Web, POP3, SMTP—Email Services, FTP—File Transfer, SNMP, Active Directory, Telnet, SSL 3.0/TLS 1.0 with strong encryption—DES, 3DES, AES, SNTP, DNS, SNMPv2, LDAP, PPP, DHCP, BOOTP, RARP, ARP/Ping

The list is not exhaustive, other protocols not mentioned may also be used.

Usage of Application Software

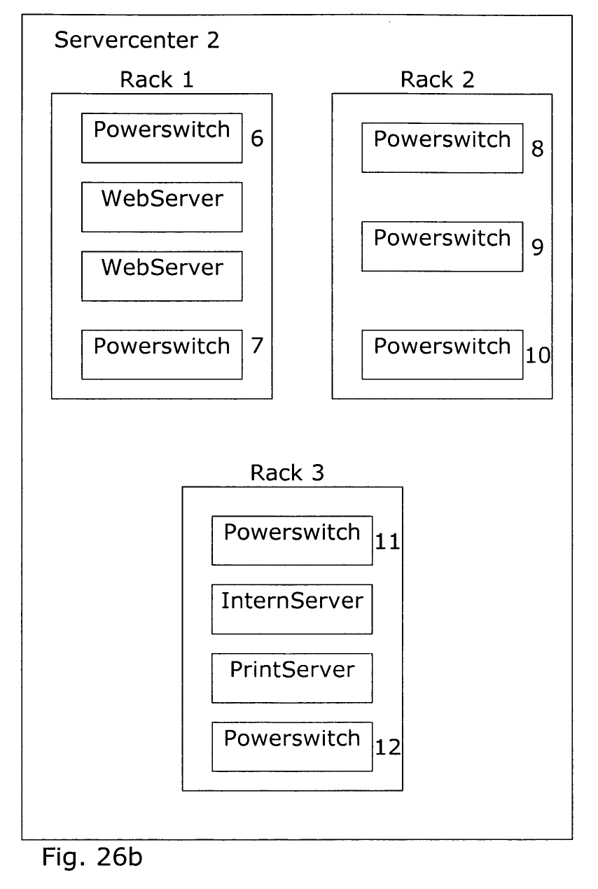

Below follows an example of how the configuration software may be used for controlling and monitoring PDUs in a network. The example is illustrated in FIGS. 26-30.

In the example there are two server centers, Server center 1 and Server center 2. The server centers may be two physically entities located in different locations. One could for example be located in Japan, and the other one could be located in Denmark.

The arrangement described in FIG. 26 hierarchically takes this form:

Servercenter 1
Rack 1
   Power switch 1 1—Outlet 1—Firewall
   Power switch 2 2
   Power switch 3 3
Rack 2
   Power switch 1 4—Outlet 4—Mail Server
   Power switch 2 5

Thus, ServerCenter 1 comprises two racks. Rack 1 comprises three PDUs wherein Power switch 1 comprises a Firewall connected to outlet 1.

Rack 2 comprises two PDUs wherein Power switch 4 comprises a Mail Server on outlet 4

Servercenter 2 comprises the following devices:

Servercenter 2
Rack 1
   Power switch 1 6—Outlet 3—Web Server 1
   Power switch 1 6—Outlet 4—Web Server 2
   Power switch 2 7
Rack 2
   Power switch 1 8
   Power switch 2 9
   Power switch 3 10
Rack 3
   Power switch 1 11—Outlet 0—Intern Server
   Power switch 1 11—Outlet 1—Print Server
   Power switch 2 12

Thus ServerCenter 2 comprises three racks, Rack 1 has three PDUs wherein Power switch 6 has two Web servers connected to its outlets, outlet 3 and 4.

Rack 2 has three PDUs with no load connected to its outlets.

Rack 3 has two PDUs, one Intern server and a Printer server, wherein Power switch 11 has the Intern server connected to outlet 0 and the Print Server connected to outlet 1.

Normally an administrator would keep track of where the PDUs are located and what load that is connected to each outlet. I.e. the administrator would have a list of the arrangement of the devices, location, the status of each device, etc.

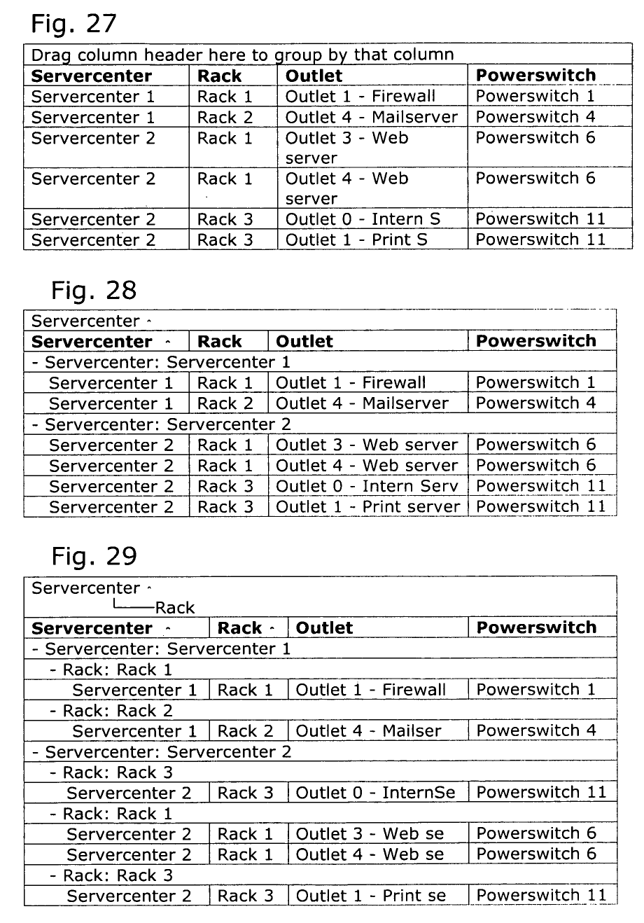

By using the config-software and adding the fields “Servercenter”, “Rack”, “Power switch#” in the program the config-software would be able to generate the following list, also shown in FIG. 27.

| Servercenter | Rack | Outlet | Power switch# |
|---|---|---|---|
| Servercenter1 | Rack1 | Outlet 1 - Firewall | Power switch1 |
| Servercenter1 | Rack2 | Outlet 4 - Mailserver | Power switch4 |
| Servercenter2 | Rack1 | Outlet 3 - Web server 1 | Power switch6 |
| Servercenter2 | Rack1 | Outlet 4 - Web server 2 | Power switch6 |
| Servercenter2 | Rack3 | Outlet 0 - Intern Server | Power switch11 |
| Servercenter2 | Rack3 | Outlet 1 - Print Server | Power switch11 |

Now a user has access to all outlets independent of the PDUs and their location. Furthermore the user may be able to sort the list according to his/her own specific wishes.

For example if the user wishes to have the list sorted by server center the user simply drags the field “Servercenter” to the drag and drop location and drops the field. After that action has been performed the list will take the form according to FIG. 28. Now it is possible to see the hierarchical structure in each server center.

If the user wishes to have the list sorted by “Rack” he/she performs the same drag and drop but with the Rack field. The list will look as in FIG. 29, wherein it is possible to see information for each rack.

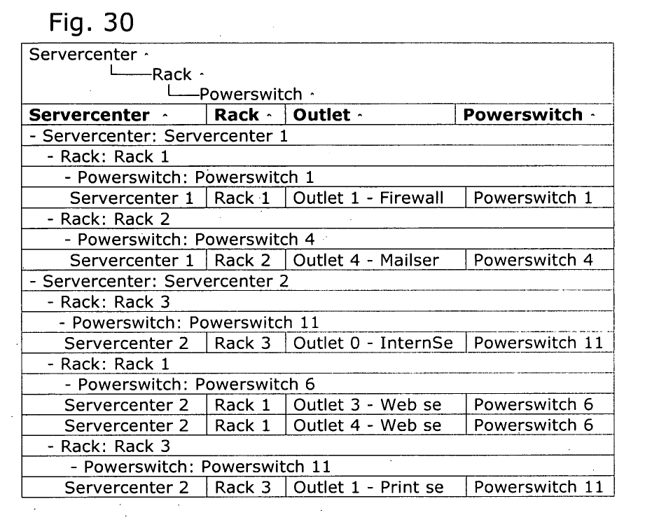

Finally if the user wants to have the list sorted by “power switch” the same action is performed and the list will now look as in FIG. 30. In this window it is easy to see information about each Power switch, where it is located, which load is connected to it, etc.

User Interface—Windows at Start-Up

First Program Start

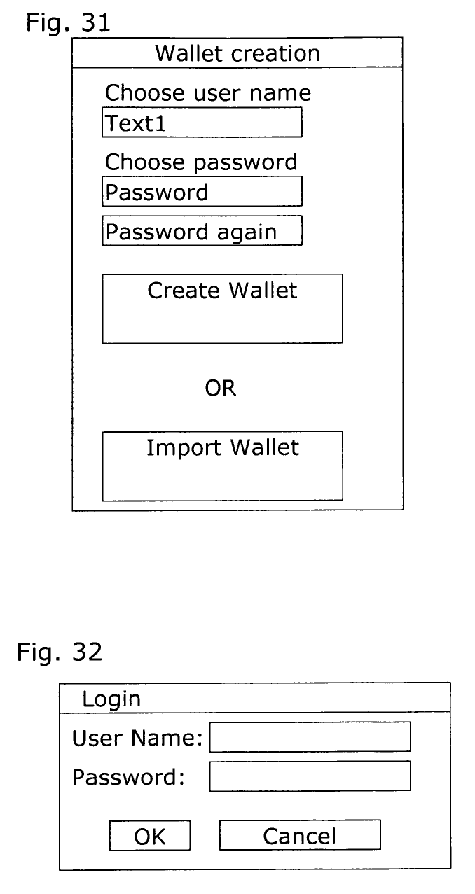

The first time the program is used it is examined if a “wallet” has been established. If a wallet has not been established the window illustrated in FIG. 31 may be shown.

Wallet

The wallet is an electronic purse preferably an encrypted file comprising all the logins and passwords to the PDUs that are to be controlled. If a wallet file has not been established the user has to answer a few questions such as a user name and a password, thereafter a wallet is established. In the cases the program has been re-installed or moved it may be possible to import the wallet file from another installation.

Normal Program Starts

If a wallet file has been created the program will not create a new wallet, instead the program may ask for a user name and password in order to open an already existing wallet, see FIG. 32.

More Users

It may be possible to have more than one user on the config-software program. In this case preferably more than one wallet file is created. The wallet files may have logins and passwords to the PDUs that are associated with that specific user so that a user can only control the PDUs in his/her wallet.

Preferably the config-software has one user, this user may have access to all PDUs in the network.

At Program Start

The program may start when a correct user name and password has been entered and after the program has been able to open the wallet file.

If the Wallet is Empty

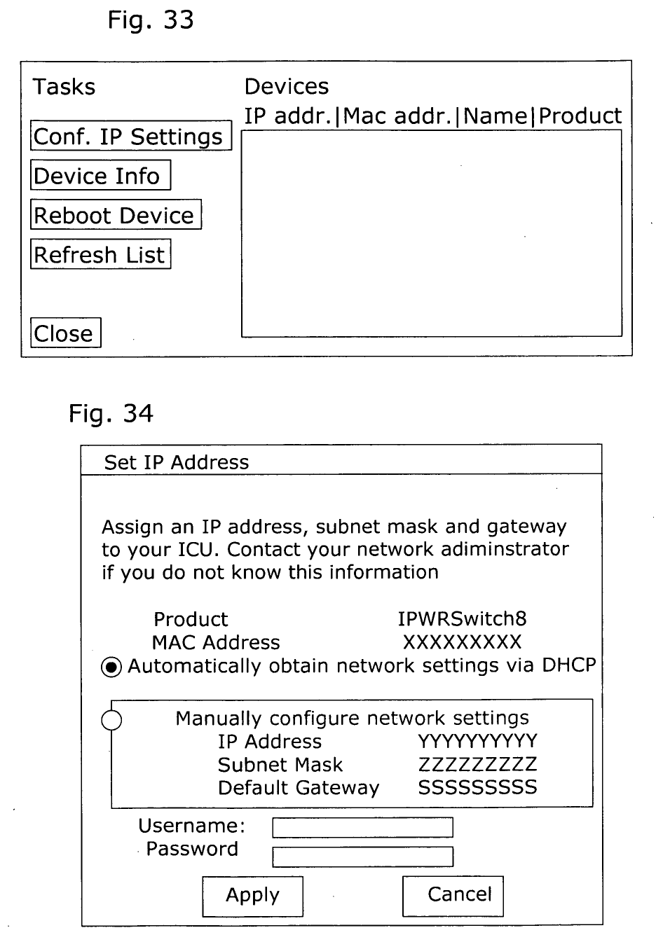

If the wallet is empty a search is started on the network via the ICU protocols, such as by ADDP, that may find the number of ICU switches connected to the network. FIG. 33 shows an example of how such a search window may look.

For each new device that the system discovers, the user may have to decide if it is a PDU that he/she wants to configure.

Usually it relates to:
already configured PDUs (already configured by the program—recognised)
shall the PDU be configured
Shall this PDU not request to be configured.
Only at manual scanning.

At program start the program may search on the Internet for PDUs. All PDUs will preferably send a response to the program telling the program of its existence.

It may not be certain that one administrator will control all PDUs from the same user terminal or even that the administrator will have the access right to all them. Therefore it may be possible for an administrator to mark a PDU as not desired to configure.

For example in the case many PDUs are mounted in the same rack, and the rack hosts many customers. In this case a system administrator may want to give the customers the possibility to control their own PDU or outlets, so that they can switch the outlets On or Off.

Thus customer A may actually be able to see customer Bs PDUs however customer A shall only be able to administrate his own PDUs and should preferably not know that there exist PDUs that he hasn't configured. Therefore it may be desirable to make customer Bs PDUs invisible to customer A, by instructing the PDU that it should not be configured.

Thereafter the network configuration may be decided:
DHCP or
Manual/static network settings

And the user information:
Username
Password

This form is illustrated in FIG. 34.

At configuration an XML-block may be created and stored in the wallet. Preferably the XML-block has the following tags:

<wrack>

<wallet>

<user></user>
<password></password>

</wallet>
<ip></ip>
<mac></mac>

</wrack>

<admin />
<password />

</IpsW>

When a user pushes the “Apply” button, XML information from the concerned PDU is collected and preferably stored in the PDU and locally in the user terminal. The “network settings” block below is changed and thereafter the XML-file is uploaded again into the PDU.

− <DHCP>

<REBOOT />

</DHCP>
− <STATIC_IP>

<IP></IP>
<GATEWAY></GATEWAY>

<REBOOT />

</STATIC_IP>

If the Wallet Contains PDU Posts

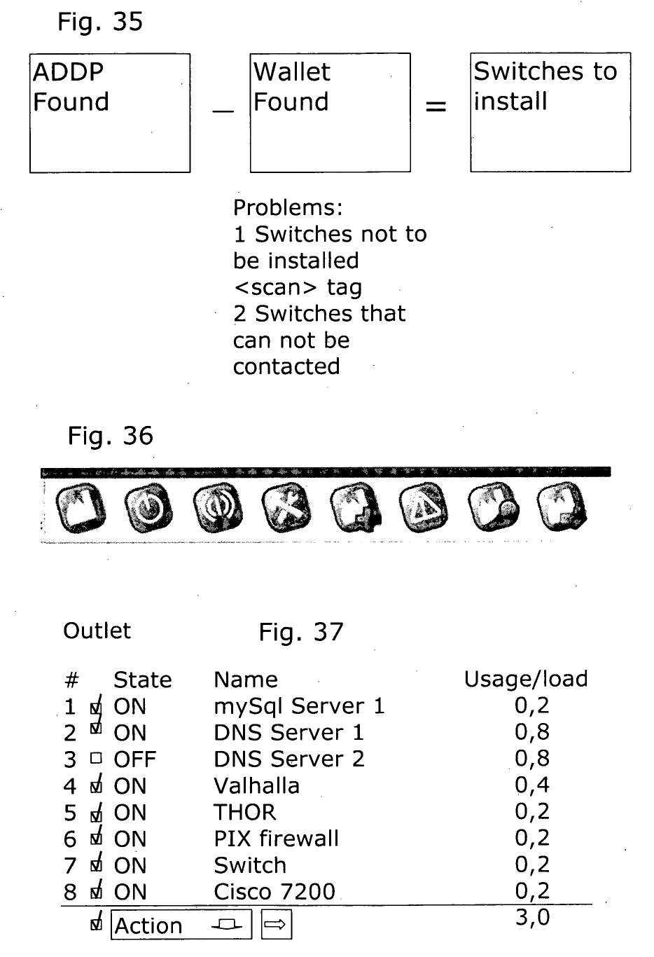

If the wallet already comprises PDU posts this means that the program has been used at least once before. Essentially the same events occur as if the wallet was empty, however there is a difference, and that is that the program preferably does not question the user about configuration of PDUs that are already existing in the wallet, see FIG. 35.

PDUs that Cannot be Contacted

There may be some cases wherein a user wants to contact a PDU but can not contact it via the ADDP because some routing rules or firewalls, etc. In these cases it is possible to add the PDU to the config-software manually by addressing the PDU via its IP address.

PDUs not Configurable with Protocols not Comprising IP

Above it may be preferred to configure the network settings via ADDP. However, in the cases where the PDU may not be contacted by ADDP, the PDU may still be configured locally or directly for example by connecting a cable directly between the PDU and the user terminal.

User-Interface—Windows During Normal Use

Mainform

When the configuration program has found and configured all the PDU, the mainform may start. From the mainform a user can control the system, see FIG. 25.

The mainform in FIG. 25 is divided into different fields numbered from 31 to 35. The field in the top 31 may comprise a menu from where a user can choose between different functions. The next field below 32 may contain an “icon-line” whereby a user can navigate between the different functions. Icons for the most central functions for controlling the PDUs may be located here. There is no limitation of the number of icons in this section, in a preferred embodiment there may be 4 to8 icons. In the middle to the right is a control called list-box 33. In the middle to the left is the property-control box 34 and beneath that one is the action and/or warning control 35. Not shown in the figure is the search function, preferably located between the icon-line and the property-control. The search function may be used to find posts in the list-control window.

Menu—Mainform

The menu preferably comprises the basic functions that may also be displayed in the icon-list, furthermore the menu may comprise the other functions described in this document.

The Icon-Line

The Icon-line, see FIG. 36 is a visual navigation control bar preferably for the basic functions of the program. From left to right the following functions may be accessed via the icons:
1. PDU Icon
2. Outlet Icon
3. Sensor Icon
4. Actions Icon (PDU sends information about actions for example On/Off and thresholds, etc.)
5. Add PDU Icon (Manually if PDU is located on other network, ip address, passwd, etc.)
6. Warnings Icon (PDU sends information about predefined thresholds such as temperature)
7. Rescan Icon (Searches for new PDUs at startup or when manually triggered by user)
8. Backup Icon (Saves a back-up)

Below follows a more detailed description of the different functions.

PDU Icon

The PDU view is preferably the default view shown in the list-box 33, when the program starts this may be the view that a user will normally see. When a user clicks the PDU-icon the list-box 33 in FIG. 25 is updated with data from the XML-files.

<POWERSTRIP><NAME>Printserver powerstrip</NAME>
<POWERSTRIP><LOCATION>RACK 11
Our Wallet <IP>

It may also be possible for a user to add own fields into the <POWERSTRIP> block. Preferably new fields may be established by right clicking a grid not shown called “create fields” or “add new tag”.

User-defined fields may be prefixed with “USER_DEF_” for example <USER_DEF_FIELDNAME>. By double clicking on this view a configuration form is opened wherein it is possible to change <Name> <Location> and Userdef fields and network configuration <NETWORK_SETTINGS>.

Property Box—Outlet

Property box—Outlet 34 in FIG. 25 may be updated with information relating to the PDU marked with one click in the list-box 33. At startup, the record at the top of the list in the list-box is chosen as default. The header for this field may be “Outlets” and preferably shows data related to the outlet-data from the PDUs XML file, see FIG. 37:

<OUTLET> <NAME>OUTLET0
Information about the status of an outlet On or Off.
Information regarding power consumption.

The above information is preferably retrieved from the PDU in real-time, and therefore not necessarily in the XML file.

Preferably the information is retrieved/sent by using SSL 3.0 or any other protocol suitable for the purpose, such as SOAP or the like.

By clicking on the outlet icon the program switches to outlet view. But instead of listing all outlets, preferably only the outlets on the relevant PDU are listed.

Property Box—Sensors

The sensor property box 35 in FIG. 25 is updated with data from the sensor tag:

<SENSOR><NAME>INTERNAL_CURRENTSENSOR_0
<SENSOR><VALUE>

A click on this icon results in the sensor property box 35 switching to sensor view. But instead of listing all sensors, preferably only the sensors on the relevant PDU are listed.

Property Box—Users

User property-box is updated with data from <PASSWORD>

<PASSWORDS>

<MASTERPASSWORD>mkey</MASTERPASSWORD>
<PASSWORD_OUTLET0>mkey</PASSWORD_OUTLET0>

...

A click on this control opens a configuration form whereby new users can be created and access levels can be assigned to them.

Property Box 2 (Up Sequence)

The Up sequence property-box is preferably updated with data from:

− <SEQUENCE>
− <SEQOUTLET>

<POSITION></POSITION>
<UPWAIT_SEC></UPWAIT_SEC>
<DOWNWAIT_SEC></DOWNWAIT_SEC>

```
    </SEQOUTLET>
  − <SEQOUTLET>
```

<POSITION></POSITION>
<UPWAIT_SEC></UPWAIT_SEC>
<DOWNWAIT_SEC></DOWNWAIT_SEC>

```
    </SEQOUTLET>
  ....
  .... (There are preferably eight of these blocks <SEQOUTLET>
```

</SEQOUTLET>, one for each outlet.)

</SEQUENCE>

A click on this control opens a configuration form wherein it is possible to set the order in which the outlets may be turned On or Off. Furthermore the waiting time in seconds before next outlet is turned On or Off may also be set.

Property Box 3 (Down Sequence)

The Down sequence property-box may preferably be updated with data from:

− <SEQUENCE>
− <SEQOUTLET>

<POSITION></POSITION>
<UPWAIT_SEC></UPWAIT_SEC>
<DOWNWAIT_SEC></DOWNWAIT_SEC>

```
    </SEQOUTLET>
  .....
  .....
  (There are preferably eight of these blocks <SEQOUTLET>
```

</SEQOUTLET>, one for each outlet.)

</SEQUENCE>

A click on this control opens a configuration form wherein it is possible to set the order in which the outlets should be turned On of Off, and how long the system should wait before switching the next outlet On or Off. The time between the outlets may be different according to the input from a user.

Property Box 4 (Network)

The Network property-box is updated with data from <NETWORK_SETTINGS> and <POWERSTRIP>

− <POWERSTRIP>

<MAC></MAC>
<NAME> </NAME>
<LOCATION> </LOCATION>
<powerstrip_Id></powerstrip_Id>
<_USER_DEFuser_x0020_field>
</_USER_DEFuser_x0020_field>

```
  </POWERSTRIP>
  −<DHCP>
```

<REBOOT />

```
  </DHCP>
  − <STATIC_IP>
```

<IP></IP>
<GATEWAY></GATEWAY>

```
  <REBOOT/>
  </STATIC_IP>
```

By clicking on this view a configuration window is opened wherein it is possible to change <Name> <Location> and Userdef fields and network settings <NETWORK_SETTINGS>.

Version

The Version property-box is updated with data from:

<VERSION_INFO>

<XML_VERSION></XML_VERSION>
<ATMEL_FIRMWARE_VERSION></ATMEL_FIRMWARE_VERSION>
<DIGI_FIRMWARE_VERSION></DIGI_FIRMWARE_VERSION>

</VERSION_INFO>

2. Outlet Icon

When a user clicks on the Outlet-icon, the list-box 33 is updated with data from the XML-files

− <OUTLET>

<POSITION></POSITION>
<NAME></NAME>
<TYPE></TYPE>
<GROUP></GROUP>
<DESCRIBTION></DESCRIBTION>
<Usage></Usage>
<Status> </Status>

</OUTLET>
− <POWERSTRIP>

<MAC></MAC>
<NAME> </NAME>
<LOCATION> </LOCATION>
<powerstrip_Id></powerstrip_Id>
<_USER_DEFuser_x0020_field>
</_USER_DEFuser_x0020_field>

</POWERSTRIP>

It may also be possible for a user to add own/new fields to the <OUTLET> block. This may be done in the same way as for the PDU view. Again user-defined fields are prefixed with “USER_DEF_” for example <USER_DEF_FIELDNAME>. Double clicking on this view opens a configuration form wherein it is possible to change <Name> <Description><Type><Group> and Userdef fields.

Property box—Outlet 34 is thereafter updated with data from the outlet, which is marked by a user preferably by one click. At startup the outlet in the top of the list is chosen as default. The title may be ‘Outlets’ and the Outlet data comes from the PDU XML file:

<OUTLET> <NAME>OUTLET0
Information relating to the status of the outlet On or Off.
Information regarding power consumption.

The above information is preferably retrieved from the PDU in real-time, and therefore the information may not necessarily be in the XML file. Hence the information may be retrieved directly from the outlets via the Microprocessor.

Preferably the information is retrieved/sent by using SSL 3.0 or any other protocol suitable for the purpose, such as SOAP or the like.

By double clicking on this view a configuration form opens wherein it may be possible to change <Name>, <Description>, <Type>, <Group> and Userdef fields.

Property Box—Action ‘Outlet Name’—Relevant Outlet.

In this window the actual state of a given outlet may be changed. The property has the following content, see FIG. 37.

Checkbox STATE <Outlet><Name> POWERCONSUMPTION
<OUTLET> <NAME>OUTLET0
STATE - Information regarding the state of the outlet, On or Off.
(SSL)
POWERCONSUMPTION - Information regarding power consumption.
(SSL)

Below is a dropdown-control with the following options:
Power ON—Turn the power On for the outlet
Power OFF—Turn the power Off for the outlet
Cycle power—This function turns the power On and Off or the other way around.

There is also a “Go” Button in connection with the dropdown-control. The preferred sequence thereafter is that the user is questioned if he/she wants to change the status of the outlet(s). If the user answers ‘yes’ to this question, the instruction is executed.

Property Box—Action ‘All Outlets’—All Outlets from the Same PDU.

Here it is possible to change state on given outlets. The window has the following content, see FIG. 37.

Checkbox STATE <Outlet><Name> POWERCONSUMPTION
<OUTLET> <NAME>OUTLET0
STATE - Information regarding the state of the outlet, On or Off.
POWERCONSUMPTION - Information regarding power consumption.

Below is a dropdown control (Action) preferably having the following options:
Power ON—The power is turned On for an outlet
Power OFF—The power is turned Off for an outlet
Cycle power—The power is turned On or Off or the other way around
Sequence up—The power is turned On at outlets that are marked and according to a predetermined time delay.
Sequence down—The power is turned Off at outlets that are marked and according to a predetermined time delay.

To the left of the dropdown-control there is a checkbox. By marking/unmarking this checkbox all outlets are marked or unmarked.

There is also a “Go” Button in connection with the dropdown-control. The preferred sequence thereafter is that the user is questioned if he/she want to change the status of the outlet(s). If the user answers yes to this question the instruction is executed,

3. Sensor Icon

When clicking on the Sensor icon the list-box 33 in FIG. 25 is updated with data from the sensor block in the XML files.

− <SENSOR>

<NAME> </NAME>
<TYPE></TYPE>
<SERIAL_CODE></SERIAL_CODE>
<SERIAL_LOCK></SERIAL_LOCK>
<DESCRIBTION> </DESCRIBTION>

</SENSOR>

It may be possible for a user to add his/her own fields to the <SENSOR> block. By double clicking on this view a configuration window is opened wherein data relating to the sensors may be changed.

Warning Property

The Warning property is preferably updated with data from the sensor block in the XML files.

− <WARNING>

<NAME>WARNING1</NAME>
<TYPE>ONOFF</TYPE>
<MAILSERVER>2</MAILSERVER>
<FROM>BOX1</FROM>
<TO>administrator@xxxxx.com</TO>
<MESSAGE>Outlet 0 turned off ! load exceeded

10A</MESSAGE>

<LTEQTHRESHOLD>11</LTEQTHRESHOLD>

</WARNING>

By clicking this property a configuration form is opened wherein it is possible to change settings for the warning.

Action Property

The Action property is preferably also updated with data from the sensor block in the XML file.

− <ACTION>

<NAME>ACTION4SENSOR0</NAME>
<TYPE>ONOFF</TYPE>
<EQTHRESHOLD>11</EQTHRESHOLD>
<OUTLETS>0:0,2:0,4:0,6:0</OUTLETS>
<MAILSERVER>2</MAILSERVER>
<FROM>BOX1</FROM>
<TO>administrator@xxxxx.com</TO>
<MESSAGE>Outlet 0 turned off ! load exceeded

10A</MESSAGE>

</ACTION>

Also the settings in this one may be changed by using a configuration form.

New Warning/Action

In this property a user may create a new Warning or Action for a sensor. Preferably thresholds may be set, such as an upper limit and a lower limit.

Enable Logging

In this property it is possible to create a path, a file name and a time interval, so that the program can log sensor values to a file, preferably in CVS format. However, any other format suitable for the task may also be used.

Preferably a tag similar as described below is saved:

<Sensor_serial_code>
<log_enable>
<Path_and_file>
<Interval>

The tag may be saved in the XML block, that may be stored in the wallet. Another option could be to save the data in the memory of the PDU or user terminal.

Warning Log, Action Log (from the PDU)

The Warning log property-box and Action log property-box may be updated with data from the PDU.

4. Action Icon

By clicking this icon the action-log is retrieved from the PDUs and displayed in the list-box 33 sorted by date and time. Preferably the Log-line and the PDU information (name/location) is shown.

5. Add PDU Icon

By clicking this icon a configuration form is opened whereby it is possible to add a new PDU. This is the manual way to do it, preferably it may be done if the new PDU is not found by the system, such as when the PDU can not be contacted by ADDP.

6. Warnings Icon

By clicking this icon the warning-logs from the PDU are retrieved and displayed in the list box 33, preferably sorted according to date and time. Information such as log line and PDU information (name and location) may be shown.

7. Rescan Icon

By clicking this icon the ADDP scanning is activated and thereafter the procedure is the same as in the case where the wallet comprises PDU posts.

8. Backup Icon

By clicking this icon the XML configuration file for all PDUs in the system is retrieved and stored.

The Sensor System

Integrated Sensors

The PDU has a number of built-in sensors that measures the power consumption on each outlet.

The following meters may be present in a PDU:

Ammeter 0—power consumption outlet 0

Ammeter 1—power consumption outlet 1

Ammeter 2—power consumption outlet 2

Ammeter 3—power consumption outlet 3

Ammeter 4—power consumption outlet 4

Ammeter 5—power consumption outlet 5

Ammeter 6—power consumption outlet 6

Ammeter 7—power consumption outlet 7

Ammeter V—(Virtual ammeter which is ammeter 1-7 accumulated.)

Sensor-Bus

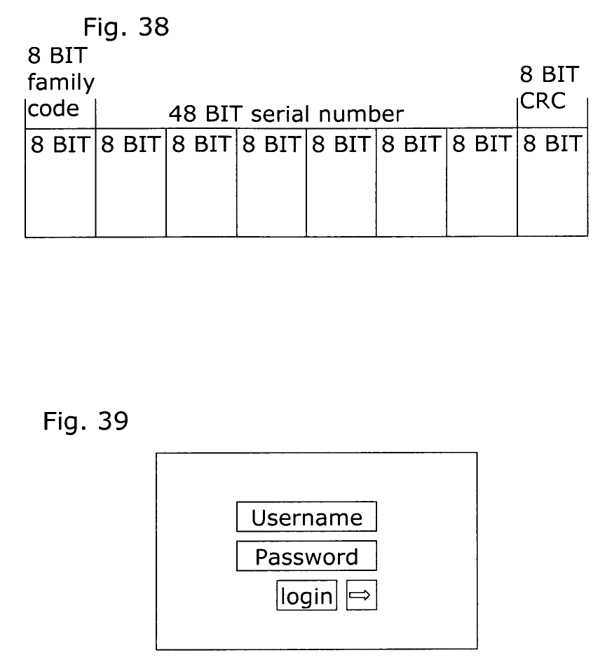

The PDU has preferably an integrated sensor-bus to which up to 30 sensors may be connected. Each sensor may use a form for NIC and preferably a unique network identification form such as a 64 bit “Mac” used by the dallas 1 wire system address illustrated in FIG. 38.

Via the sensor-bus the PDU may communicate with the sensors by for example Sms, Serial RS-232, USB, Firewire, 1-Wire, I2C, etc.

Some of the sensors that may be used in connection with the PDU are: Temperature sensors, Analogue/digital converter sensor, Digital/Digital converter sensor, Water sensor, Humidity sensor, Smoke sensor, ON/Off sensor, USB sensor, Serial sensor, I2C sensor, 1 wire sensor, Ethernet sensor, IR sensor, Audio sensor, Flow sensor, Motion sensor,

Each sensor preferably has a unique serial number which makes it possible to differentiate each sensor in the system.

In the XML file the sensors may be described as follows:

− <SENSOR>

```
  <NAME>INTERNAL_CURRENTSENSOR_0</NAME>
  <TYPE>0</TYPE>
  <SERIAL_CODE>xxxx-yyyy-zzzz-ss</SERIAL_CODE>
  <SERIAL_LOCK>tttt-rrr-ew-1</SERIAL_LOCK>
  <DESCRIBTION>Current sensor</DESCRIBTION>
− <WARNING>
```

<NAME>WARNING1</NAME>
<TYPE>ONOFF</TYPE>
<GTTHRESHOLD>11</GTTHRESHOLD>
<MAILSERVER>1</MAILSERVER>
<FROM>BOX1</FROM>
<TO>administrator@xxxxx.com</TO>
<MESSAGE>Outlet 0 turned off ! load exceeded

10A</MESSAGE>

</WARNING>
− <ACTION>

<NAME>ACTION1SENSOR0</NAME>
<TYPE>ONOFF</TYPE>
<EQTHRESHOLD>41</EQTHRESHOLD>
<OUTLETS>0:0,1:1,2:0,3:1,4:0,5:0,6:1,7:0</OUTLETS>
<MAILSERVER>2</MAILSERVER>
<FROM>BOX1</FROM>
<TO>administrator@xxxxx.com</TO>
<MESSAGE>Outlet 0 turned off! Load exceeded

10A</MESSAGE>

</ACTION>
− <ACTION>

Preferably each sensor has a:

- <NAME> - Name
- <TYPE> - Type information - for example temperature
- <DESCRIBTION> Description (for example where the sensor is
located, etc.)

The sensors “MAC” address may be stored in the tag—<SERIAL_CODE>

Safety Precautions

In order to protect the PDUs against un-authorised sensors. Preferably only sensors having an approved <SERIAL_LOCK>may be used

The Serial_Lock System

After the configuration software has detected a new sensor, the sensor may preferably be configured before it is put to use. During the configuration of the sensor the <SERIAL_LOCK> may be retrieved from the enclosed software/information following the sensor. The serial_lock is thereafter stored in the system, so that preferably only authorised sensors may be used in the system.

Method for Detecting New Sensors

The PDUs may detect new sensors by themselves. However two problems can make the process insecure, since:
we do not know the sensor in advance,
we do not know what actions/warnings/thresholds a potential customer may wish to have.

However a sensor may be connected to the system anyway. Preferably it will not be up and running before it is detected by the configuration system and before it is integrated into the XML file that is stored on the PDU.

Therefore the preferred method for detecting sensors may comprise the following steps:
Retrieve the XML-file from the PDU.
Retrieve a list over existing sensors connected to the PDU.
Compare the sensors by comparing their unique <SERIAL_CODE>

Installation and Configuration of Sensors

When a new sensor has been detected it may have to be configured and installed. This may be done by using XML code from the configuration belonging to the sensor, or from a homepage on the Internet.

Thereafter the user has the possibility to add an arbitrary number of warnings of actions that may be related to the sensor. Preferably an email server may be used for sending messages to for both types of events. However other ways for communicating the messages may be used such as sms, etc.

A form for configuration of the sensors may be used in order to make it easier for a user. The form may comprise:
Action/warning type selector, from which a user can choose a predefined action/warning or choose to create a user defined action/warning.
Event type selector, from where a user can choose a predetermined event or create a user-defined event.
Window for inputting threshold value such as temperature, voltage, humidity, etc. Furthermore it may be possible to input an upper value and a lower value in order to create a window wherein the values may be.
A list of the outlets that may be related to the action that has been chosen. The outlets can be chosen or a window for inputting name and number for the outlet may be provided.
A mail part comprising a From window, a To window, a Message window and a Mailserver selector for selecting mail server.

Furthermore, each sensor may have an arbitrary number of actions or warnings related to it.

The Web Interface

The system may also be controlled from a remote location by use of a web interface. In this section the web interface will be described.

Login

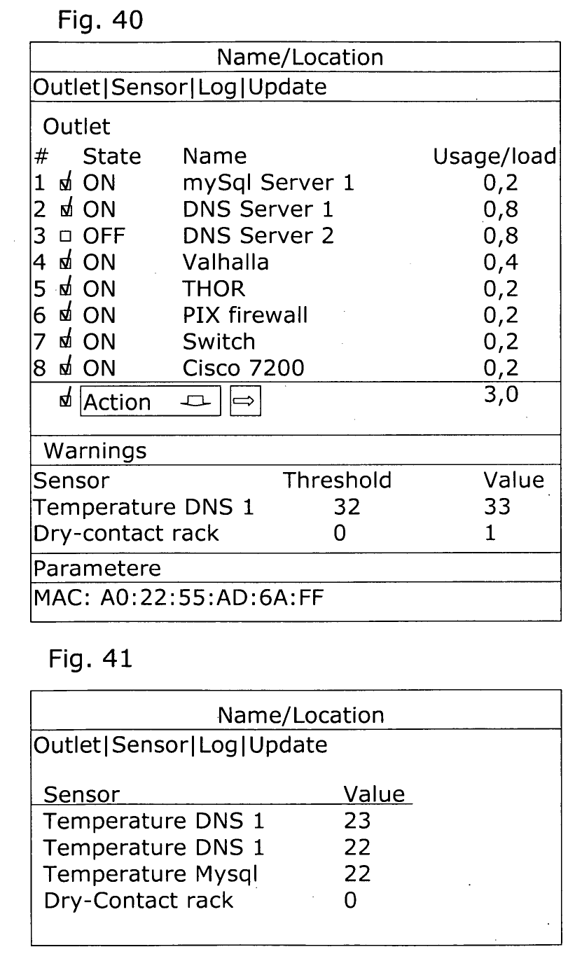

When using the web interface the user will be presented to a login window as shown in FIG. 40. The user has to login by entering user name and password. Preferably all pages are password protected, unless there is a page containing information or a function which is of no importance from a security point of view. The user name and password is merged and preferably a Hash Algorithm fingerprint is calculated.

Pseudocode fingerprint=Hash algorithm (“user name” concat “password”)

This fingerprint may preferably be the same as the fingerprint in the XML-file.

(<PASSWORDS><MASTERPASSWORD>fingerprint</MASTERPASSWORD>).

If these match the user will be able to access the system and the Main page will be loaded on a display.

Main Page—Outlet

The main page is illustrated in FIG. 40, preferably it has four submenus: Outlet|Sensor |Log|Update. From the main page a user may choose any of the submenus.

Submenu—Outlet

Outlet may be an alias for the main page and hence also points towards this. Sensor, Log and Update will be described later in this document.

The headline Name/Location in the upper part of the window is retrieved from the XML-file.

<POWERSTRIP>

<NAME>Name</NAME>
<LOCATION>Location</LOCATION>

The outlet block in the XML file comprises a list of outlets. Preferably the state of the outlets may also be represented by a colour code such as green=On, red=Off in the web interface. The states may be retrieved by sending a request to the Microcontroller whereupon the Microcontroller answers. Preferably the status is represented by 1 byte and informs which of the outlets that are in the state “On”. The bit pattern is preferably inverted so that an answer such as 255 (1111 1111) would be inverted to 0, hence (0000 0000) and would inform that the state of all outlets are “Off”. Name of outlets may also be retrieved from the XML-file <OUTLET0> <NAME>OUTLET0</NAME>, etc.

The usage/load column preferably informs how many amperes each outlet is using. The values may be retrieved by sending a request to the Microcontroller, the powermeters preferably relate to a value between 0-7. An answer is sent back, wherein the value represents the load on the outlet. The total load may be calculated and displayed below the column as shown in FIG. 40.

To the left of the state column there are checkboxes whereby a user can mark an outlet. Below there is a checkbox for unmarking the outlets, by marking this checkbox a user can unmark all checkboxes at once.

From the dropdown menu it is possible to choose an action that will be related to the marked outlets. Preferably an extra window will appear asking the user if he/she really wants to XXX on outlets 1 . . . 8, and gives the user two options Ok/Cancel. After the user has clicked one of these buttons, the action will be associated to the outlets and performed when predetermined thresholds or events occur. Preferably all Actions in the dropdown menu are varieties of the same commands.

Below Follows a Description of the Different Actions:

Action—Power On

In this action the power is switched On for the outlets that have been associated with this action. This may be performed by sending a request to the Microcontroller in the PDU comprising a message. The Microcontroller sends back an answer. Preferably the “ ” outlets_to close, outlets_to open and outlets_that_are open answer, each of them is 1 Byte and informs which outlet that is open (On). Furthermore the bit pattern is inverted and for each outlet that is switched On, a log line is added in the Action-log such as: “Outlet X;on; YYYY-MM-DD HH:mm:SS”.

Action—Power Off

In this action the power is switched Off for the outlets that have been associated with this action. The process is similar to the one above wherein an instruction is sent to the Microcontroller and the Microcontroller returns an answer comprising a checksum, etc. For each outlet that is switched Off, a log line is added in the Action-log.

Action—Cycle Power Action—Sequence Up and Sequence Down

In these actions the power is switched On or Off for the outlets that have been associated with this action. In what order and at what time the outlets are switched On or Off may be described in the XML-file, below follows an example of such a structure:

− <SEQUENCE>
− <SEQOUTLET>

<POSITION></POSITION>
<UPWAIT_SEC></UPWAIT_SEC>
<DOWNWAIT_SEC></DOWNWAIT_SEC>

</SEQOUTLET>

```
  − ...
  − ...
  − ...
  − ...
  − ...
  − ...
  − <SEQOUTLET>
```

<POSITION></POSITION>
<UPWAIT_SEC></UPWAIT_SEC>
<DOWNWAIT_SEC></DOWNWAIT_SEC>

</SEQOUTLET>

</SEQUENCE>

Submenu—Sensor

In the sub menu “Sensor” see FIG. 41, at least some of the sensors that are connected to the system may be displayed. The name is preferably retrieved from the XML file:

<SENSOR1>

<NAME>XXX</NAME>

<SERIAL_CODE>FFFFFFFFFFFFFFFF</SERIAL_CODE>

Thereafter sensors are requested by using the sensor “Serial code”, and the microcontroller sends a value back, which is displayed in the column “Value”.

Submenu—Log

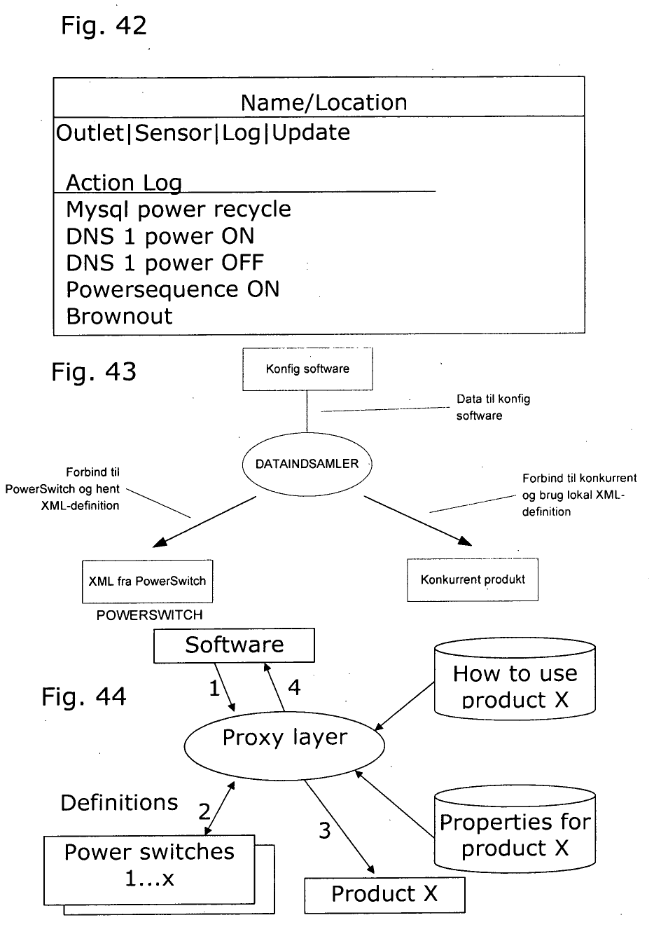

In the Log window the latest actions that have been executed may be displayed, see FIG. 42.

Submenu—Update

The firmware in the ICU may be updated via the web interface. The new firmware may be installed when the PDU is re-started/rebooted.

Preferably a bootloader is used that may always be able to choose between two or more firmware-images at start-up (the new one and the old one). Furthermore the bootloader is able to verify that the firmware is not corrupt before up-start. If the new firmware is corrupt the old one will be used.

Simple Client Interface

Preferably a simple client/user interface is provided that may be used by user terminals such as by PDAs and mobile phones, etc.

The simple client interface preferably has the same functions as for the normal user interface, however, the design and some of the functions may be simplified in order for the interface to work faster on a smaller user terminal, such as a mobile phone not having the same processing power as a stationary user terminal.

Preferably it is possible to inquire network settings and to initialise a reboot of a PDU. This may be done by creating a password protected “pass through” function such as a homepage to which a user terminal may send parameters. In this way it may be possible to instruct the microprocessor and hence control the outlets.

Simple Kernel

As described earlier the PDU is able to act on its own independently of other devices or human interaction. For this reason a kernel program has been developed that X times per minute checks sensors and executes an Action or Warning if necessary and as described in the XML-file. Each sensor may have an entry in the XML-file, and there is an arbitrary number of Actions and Warnings associated with each sensor. A warning may be sent as an email and an action is preferably to switch the state of one or more outlets, an email may also be sent when an action has been executed since the administrator should be informed about the event.

Below is an example of the XML file for a sensor having one associated warning and one associated action.

```
− <SENSOR>
  <NAME>INTERNAL_CURRENTSENSOR_0</NAME>
  <TYPE>0</TYPE>
  <SERIAL_CODE>xxxx-yyyy-zzzzz-tt</SERIAL_CODE>
  <SERIAL_LOCK>rrrrr-sss-ew-1</SERIAL_LOCK>
  <DESCRIBTION> Current sensor </DESCRIBTION>
  −<WARNING>
```

<NAME>WARNING1</NAME>
<TYPE>ONOFF</TYPE>
<GTTHRESHOLD>11</GTTHRESHOLD>
<MAILSERVER>1</MAILSERVER>
<FROM>BOX1</FROM>
<TO>administrator@xxxxx.com</TO>
<MESSAGE>Outlet 0 turned off! Load exceeded

10A</MESSAGE>

```
  </WARNING>
  − <ACTION>
```

<NAME>ACTION1SENSOR0</NAME>
<TYPE>ONOFF</TYPE>
<EQTHRESHOLD>41</EQTHRESHOLD>
<OUTLETS>0:0,1:1,2:0,3:1,4:0,5:0,6:1,7:0</OUTLETS>
<MAILSERVER>2</MAILSERVER>
<FROM>BOX1</FROM>
<TO>administrator@xxxxx.com</TO>
<MESSAGE>Outlet 0 turned off! Load exceeded

10A</MESSAGE>

```
  </ACTION>
  − <ACTION>
```

If the type is “INTERNAL_CURRENTSENSOR_X” it is an internal ammeter whereon the value should be measured. X relates to the position of the ammeter, and 0 implies that the ammeter is connected to outlet no 0.

Thus the Kernel program initiates an instruction that preferably is sent to the Microcontroller, instructing which meter that should be metered. The Microcontroller answers back preferably with a value and checksum, etc. The value is compared with the threshold values in each action and/or warning. Preferably there are five types of comparisons:
EQTHRESHOLD—The value is equal to threshold value
GTTHRESHOLD—The value is higher than the threshold value.
LTTHRESHOLD—The value is less than the threshold value.
GTEQTHRESHOLD—The value is higher than or equal the threshold value.
LTEQTHRESHOLD—The value is less than or equal the threshold value.

If one of these criteria's is true, an action or warning may be executed. An executed warning is logged in a warning file and an executed action is logged in an action-file. Preferably all actions may be logged in the Action log—for all outlets that the action is associated with and all warnings may be logged in the warning-logg—for all outlets that the warning is associated with.

The outlet that are affected in an action may be addressed by the code: OUTLETS (OUTLETS=“0:0,1:0,2:0,3:0,4:0,5:0,6:3,7:0”)

The data for the outlets is preferably written in pairs wherein the data is separated by a comma (,). A colon (:) may separate the pairs.

The digit to the left in each pair relates to the number of the outlet, hence it may take the value between 0-7 for a PDU having 8 outlets, and 0-15 for 16 outlets, etc.

The digit to the right of the colon represents the number of seconds that the PDU shall wait before it moves on to the next outlet in line. Thus 6:3 implies that outlet 6 is switched On or Off, thereafter the PDU should wait for 3 seconds before going on to the next, outlet number 7.

The type of executed action may be decided by TYPE (TYPE=“ONOFF”) means that the outlet switches from On to Off.

− <MSERVER>

<SMTP>smtp3.xxxxx.com</SMTP>
<PASSWORD>xxxxxx</PASSWORD>
<PORT />

</MSERVER>

If it is mentioned a MAILSERVER/FROM/TO, a mail is sent comprising the FROM/TO and MAILSERVER values. The SUBJECT may preferably be “ACTION” or “WARNING”. The mail body may hold information regarding NAME and LOCATION from the POWERSTRIP in the XML file, see below.

− <POWERSTRIP>

<MAC>00:40:9D:23:9F:9E</MAC>
<NAME>Printserver powerstrip</NAME>
<LOCATION>RACK 11</LOCATION>
<powerstrip_Id>0</powerstrip_Id>
<_USER_DEFuser_x0020_field>testvalue</_USER_DEFuser_x0020_fiel

d>

</POWERSTRIP>

Furthermore the mail may comprise information relating to TYPE of the Action/Warning and which OUTLETs that have been switched.

Messages that belong to the individual Action/Warning for example “Outlets turned off—load exceeded 10 A” and sensor/values that have taken part in the event.

Moreover there may be a sensor-type called “INTERNAL_TOTALCURRENTSENSOR”

<NAME>INTERNAL_CURRENTSENSOR_X</NAME>
<TYPE>0</TYPE>
<SERIAL_CODE>1</SERIAL_CODE>
<SERIAL_LOCK>1</SERIAL_LOCK>
<DESCRIBTION>DDD</DESCRIBTION>

This type may be treated in the same way as INTERNAL_CURRENTSENSOR_X with the difference that the values that are used for threshold evaluation/comparison is the accumulated value of INTERNAL_CURRENTSENSOR_{—}0 to INTERNAL_CURRENTSENSOR_{—}7.

Exchangeable Sensors.

<SENSOR2>

<NAME>XXX</NAME>
<TYPE>YYY</TYPE>
<SERIAL_CODE>FFFFFFFFFFFFFFFF</SERIAL_CODE>
<SERIAL_LOCK>FFFFFFFFFFFFFFFF</SERIAL_LOCK>
<DESCRIBTION>DDD</DESCRIBTION>

<ACTION TYPE=″ONOFF″ EQTHRESHOLD=″60″

OUTLETS=″0,2,4,6″ MAILSERVER=”MAILSERVER1”
FROM=”BOX1”TO=”administrator@xxxxx.com”>
Temperature too high!</ACTION>
<ACTION TYPE=″OFFON″ EQTHRESHOLD=″20″
OUTLETS=″0,2,4,6″>Temperature OK!</ACTION>
<WARNING TYPE=″ONOFF″ THRESHOLD=″50″
OUTLETS=″0,2,4,6″>Temperature too
high!</WARNING>
<WARNING TYPE=″OFFON″ EQTHRESHOLD=″18″
OUTLETS=″0,2,4,6″>Temperature OK!</WARNING>

</SENSOR2>

This type of sensor may also be treated as INTERNAL_CURRENTSENSOR_X with the difference that the value, which is being used for threshold comparison, is requested using the serial code and serial lock

File System

Preferably a file system is used for up and downloading of files to/from the ICU. Download may be performed as a normal http call and upload may be performed as a normal http file upload. The function may be used to Up and Download the XML-file.

When a PDU is powered-up after having been powered-down, the outlets may preferably be started according to UP_SEQUENCE, see Action—Sequence up. The file-system makes it possible to save and retrieve: New Firmware, Action.log, Warning.log, Config.xml—XML file, Default.xml—Factory XML file,

XML—File

Below follows a description about the preferred embodiment of the XML file used in the invention. Preferably the XML file comprises information regarding the PDU, sensors and power outlets, etc. and may be sent between the PDUs and the configuration SoftWare.

Thus the XML file functions as a information carrier between the different devices connected to the network. It is preferably by using the structure and stored information in the XML file that the system is able to control the outlets and to display information on the user terminal.

Below is the overall structure of the XML file shown:

<?xml version=“1.0” encoding=“ISO-8859-1” stand-alone=“yes” ?>
− <IPSDataSet>

± <STATIC_IP>
± <OUTLET>
± <OUTLET>
± <OUTLET>
± <OUTLET>
± <OUTLET>
± <OUTLET>
± <OUTLET>
± <OUTLET>
± <SENSOR>
± <SENSOR>
± <SENSOR>
± <SENSOR>
± <SENSOR>
± <SENSOR>
± <SENSOR>
± <SENSOR>
± <PASSWORDS>
± <POWERSTRIP>
± <SEQUENCE>
± <MSERVER>
± <MSERVER>
± <MSERVER>
± <MSERVER>
± <MSERVER>

</IPSDataSet>

The Static IP block preferably comprises information related to the network and Internet gateway.

− <STATIC_IP>

<IP>1231546786</IP>
<GATEWAY>000.000.000.000</GATEWAY>

</STATIC_IP>

Each power outlet may be represented by an XML block in the XML file. In this block a user may associate data and terms to a specific power outlet, the preferred structure of an outlet block is shown below:

− <OUTLET>

<POSITION>0</POSITION>
<NAME>Router</NAME>
<TYPE>type1</TYPE>
<GROUP>GGG</GROUP>
<DESCRIBTION>DDD</DESCRIBTION>
<Usage>0.999756505535219</Usage>
<Status>false</Status>

</OUTLET>

Each sensor may be represented by an XML block. In this block a user may associate data and terms to a specific sensor. It is possible to relate at least one warning and one Action to each sensor. As described above a warnings sends a message (for example email or SMS) when a sensor have reached limit. An action is similar to a warning but also switches an outlet On or Off.

− <SENSOR>

```
  <NAME>INTERNAL_CURRENTSENSOR_0</NAME>
  <TYPE>0</TYPE>
  <SERIAL_CODE>1002-5656-45464-55</SERIAL_CODE>
  <SERIAL_LOCK>4654-135-ew-1</SERIAL_LOCK>
  <DESCRIBTION> Current sensor </DESCRIBTION>
− <WARNING>
```

<NAME>WARNING1</NAME>
<TYPE>ONOFF</TYPE>
<GTTHRESHOLD>11</GTTHRESHOLD>
<MAILSERVER>1</MAILSERVER>
<FROM>BOX1</FROM>
<TO>administrator@xxxxx.com</TO>
<MESSAGE>Outlet 0 turned off ! load exceeded

10A</MESSAGE>

</WARNING>

± <WARNING>

± <WARNING>
± <WARNING>
± <WARNING>
± <WARNING>

</SENSOR>
− <SENSOR>

```
  <NAME>INTERNAL_CURRENTSENSOR_1</NAME>
  <TYPE>0</TYPE>
  <SERIAL_CODE>1</SERIAL_CODE>
  <SERIAL_LOCK>1</SERIAL_LOCK>
  <DESCRIBTION>DDD</DESCRIBTION>
− <ACTION>
```

<NAME>ACTION1SENSOR0</NAME>
<TYPE>ONOFF</TYPE>
<EQTHRESHOLD>41</EQTHRESHOLD>
<OUTLETS>0:0,1:1,2:0,3:1,4:0,5:0,6:1,7:0</OUTLETS>
<MAILSERVER>2</MAILSERVER>
<FROM>BOX1</FROM>
<TO>adm@xxxx.com</TO>
<MESSAGE>Outlet 0 turned off ! load exceeded

10A</MESSAGE>

</ACTION>
± <ACTION>
± <ACTION>
± <ACTION>
± <ACTION>
± <ACTION>

</SENSOR>
± <SENSOR>

The Password block describes which passwords that are valid.

− <PASSWORDS>

<MASTERPASSWORD>fingerprint</MASTERPASSWORD>
<PASSWORD_OUTLET0> fingerprint </PASSWORD_OUTLET0>
<PASSWORD_OUTLET1> fingerprint </PASSWORD_OUTLET1>
<PASSWORD_OUTLET2> fingerprint </PASSWORD_OUTLET2>
<PASSWORD_OUTLET3> fingerprint </PASSWORD_OUTLET3>
<PASSWORD_OUTLET4> fingerprint </PASSWORD_OUTLET4>
<PASSWORD_OUTLET5> fingerprint </PASSWORD_OUTLET5>
<PASSWORD_OUTLET6> fingerprint </PASSWORD_OUTLET6>
<PASSWORD_OUTLET7> fingerprint </PASSWORD_OUTLET7>

</PASSWORDS>

The PDU preferably also has its own XML block to which a user may associate data that relate to the individual PDU.

− <POWERSTRIP>

<MAC>00:40:9D:23:9F:9E</MAC>
<NAME>Printserver powerstrip</NAME>
<LOCATION>RACK 11</LOCATION>
<powerstrip_Id>0</powerstrip_Id>

</POWERSTRIP>

The Sequence block in the XML file describes in which order the user wishes the PDU to switch the outlets On with (UPWAIT) and in which order to switch the outlets Off with (DOWNWAIT).

− <SEQUENCE>
− <SEQOUTLET>

<POSITION>0</POSITION>

<UPWAIT_SEC>3</UPWAIT_SEC>
<DOWNWAIT_SEC>3</DOWNWAIT_SEC>

</SEQOUTLET>

The Mserver block in the XML file describes which mail servers that the PDU may use when sending an electronic message.

− <MSERVER>

<SMTP>smtp.XXXXYY.com</SMTP>
<PASSWORD>klokpen</PASSWORD>

<PORT />

In the above description the term “comprising” does not exclude other elements or steps and “a” or “an” does not exclude a plurality.

Furthermore the terms “include” and “contain” does not exclude other elements or steps.

1. A power distribution device for controlling and monitoring states in and around a computer network, the device comprises:
at least one processor,
at least one memory,
at least one sensor port for receiving a sensor signal,
at least one sensor, for example at least one watt meter,
at least one power outlet, and
a connection to a communication network,
wherein the processor is operable to control said at least one outlet in response to information provided from the at least one sensor port and/or the at least one sensor and/or information provided from said communication network.

2. A power distribution device according to claim 1 wherein the memory comprises a unique ID.

3. A power distribution device according to claim 1 further comprising a connection to another power distribution device.

5. A power distribution device according to claim 1, wherein sensors are connected to the sensor port.

6. A power distribution device according to claim 5 wherein the processor is programmed to act according to predefined rules.

7. A power distribution device according to claim 6 wherein the predefined rules are threshold values.

8. A power distribution device according to claim 1 wherein the processor is programmed to communicate with a data structure comprising:
at least one outlet block comprising data relating to an outlet,
at least one sensor block comprising data relating to a sensor.

9. A user interface for a user terminal connected to a computer network comprising one or more power distribution devices according to claim 1, the user interface comprises a display and at least one panel/window, wherein the at least one panel comprises one or more elements.

10. A user interface according to claim 9 wherein the user interface comprises a grouping functionality for the network devices, in order to be able to assign a network device to at least one specific group.

11. A user interface according to claim 10 wherein the user interface comprises a display function which displays the network devices according to a chosen group.

12. A user interface according to claim 11 wherein the user interface comprises a display function which displays the network devices according to chosen groups.

13. A user interface according to claim 11 wherein the display function is performed by a drag and drop action.

14. A user interface according to claim 9 wherein the panels/windows relates to at least one of the following type of panels/windows:
icon list/view,
Outlet list/view,
Sensor list/view,
warning list/view,
action list/view,
Rescan list/view,
Power distribution unit list/view.

15. A method for collecting and storing data from unknown devices in a network environment, the network environment comprises a network, a user terminal, a home database, unknown network devices and a first database comprising usage information about the unknown network devices, the method comprising the steps of:
from the user terminal sending a request to a proxy/transparent layer for finding network devices,
the proxy/transparent layer find and connect to unknown network devices, and
when a unknown network device is found, collecting and storing data relating to the unknown devices in the home database.

16. A method according to claim 15 wherein the step of connecting to an unknown network device further comprises the steps of:
using the usage information stored in the first database for communicating with an unknown device.

17. A method for creating a database comprising devices in a network, the network comprising:
at least one user terminal,
a multiple of network devices and
at least one power distribution device comprising sensors and outlets for controlling the power to the network devices,
the method comprises the steps of:
scanning the network for new power distribution devices,
upon a request sent from the user terminal receiving at least one message from each new power distribution device, the message containing among other data the unique identifier of the sensors connected to the new power distribution device
assigning a belonging to the new power distribution device,
creating a record relating to each new device, and
storing the record in a database.

18. A method according to claim 17 further comprising a step of creating an encrypted wallet file, the wallet file comprises logins and/or passwords to the devices connected to the network.

19. A method according to claim 17 wherein the message comprises an XML file.

20. A method according to claim 17 wherein the scanning is executed either manually or automatically at start.

21. A method according to claim 17 further wherein the belonging relates to at least one of the following:
type of device,
location of the device,
functionality of the device,
user defined belonging.

22. A method according to claim 17 further comprising the step of contacting devices on external networks by using the IP address or domain name of the device.

23. A method according to claim 17 wherein the record comprises at least one of the following:
ip address of the device,
name of the device,
function of the device,
group belonging,
location of the device,
outlet(s),
loads on outlets,
description of the device,
sensors.

24. A method for controlling power distribution devices in a network, the network comprising:
at least one user terminal comprising a display,
a multiple of network devices,
one or more power distribution devices according to claim 1 comprising sensors and multiple outlets supplying power to the network devices,
one or more power distribution devices comprising sensors and multiple outlets supplying power to the network devices,
the method comprises the steps of:
displaying the power distribution devices and/or outlets according to a belonging of the distribution devices and/or outlets,
controlling the power distribution devices and/or outlets according to an action triggered by an input.

25. A method according to claim 24 wherein the belonging relates to at least one of the following:
type of device,
location of the device,
functionality of the device,
owner of the device,
user defined belonging.

26. A method according to claim 24 wherein the input preferably relates to at least one of the following:
input from a sensor,
input from a user,
input from Network devices,
input from other power distribution devices.

27. A method according to claim 24 wherein the action preferably relates to at least one of the following activities:
power on,
power off,
cycle power,
sequence up,
sequence down, and
user-defined power sequence.

28. A computer system comprising:
one or more power distribution device(s) according to claim 1,
one or more power distribution device(s) comprising power outlets,
a user terminal comprising a display for displaying information relating to the power outlets,
one or more electronic devices connected to the power outlets,
said computer system being programmed to:
displaying on the display, information relating to one or more of the power outlets according to predetermined belongings of the power outlets.

29. A computer system according to claim 28 wherein the predetermined belongings of the outlets is chosen from a group of belongings comprising:
type of device connected to the outlet,
location of the device connected to the outlet,
functionality of the device connected to the outlet,
owner of the device connected to the outlet,
user defined belongings,
type of sensors.

30. A computer system according to claim 28 wherein computer system further is programmed to send instructions from the user terminal to the power distribution device(s).

31. A power distribution device according to claim 1 receiving or sending information with a data structure comprising:
at least one outlet block comprising data relating to an outlet,
at least one sensor block comprising data relating to a sensor.

32. A data structure according to claim 31 further comprising at least one of the following blocks:
a network block comprising data relating to the network,
a power distribution device block comprising data relating to the power distribution device,
a password block,
a sequence block comprising data relating to the order of switching outlets on or off,
a communication block comprising data relating to sending electronic messages.

33. The data structure according to claim 31, further being adapted to being transmitted over a network in order to facilitate the updating and storing of information.
